(19) United States
(12) Patent Application Publication
(10) Pub. No.: US 2001/0017919 A1
(43) Pub. Date: Aug. 30, 2001

(54) Work reproducing system, work decoding system and user's peculiar data storing system

(75) Inventor: Hiroshi Miyano, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/790,939

(22) Filed: Feb. 22, 2001

(30) Foreign Application Priority Data
Feb. 24, 2000 (JP) 047364/2000

(51) Int. Cl. H04N 7/167; H04L 9/00

(52) U.S. Cl. 380/201; 705/51

(57) ABSTRACT

A coded work is stored in a coded work storing means 103 such that it can be decoded with user's peculiar data stored in a storing means 107. To reproduce the coded work, a word decoding system 101 and a user's peculiar data storing system 102 are connected to each other via connecting means 105 and 108. The user's peculiar data stored in the storing means 107 is transmitted via communicating means 109 and 106 to a decoding means 104. The coded work stored in the coded work storing means 103 is transmitted to the decoding means 104. Receiving the user's peculiar data and the coded work, the decoding means 104 decodes the coded work for the reproduction of the coded work. Thus it is possible to permit distribution and reproduction of a work without any particular recording medium while protecting the copyright of the work.

### BACKGROUND OF THE INVENTION

This application claims benefit of Japanese Patent Application No. 2000-047364 filed on Feb. 24, 2000, the contents of which are incorporated by the reference.

The present invention relates to work reproducing systems, work decoding systems and user's peculiar data storing systems and, more particularly, to work reproducing systems, work deciphering systems and user's peculiar data storing systems, which can protect the copyrights of electronic works while providing user's convenience.

Among works, those of languages, music, paintings, graphs and charts, movies, photographs, programs, etc. are subject to circulation and utilization of them as such or their replicas in the form of electronic works. However, such electronic works can be duplicated readily and with fidelity to their originals. In addition, in the case where an electronic work is stored in a hard disc or like recording medium, it is difficult to make a check from the outlook of the recording medium casing as to whether the work is actually stored. Therefore, a copyright owner who has circulated a replica or his or her work and gave a consent for utilizing the replica to a particular person who paid a money for the utilization of the replica, can not readily detect possible unfair utilization of the replica by a third party having no consent of utilization by unfairly duplicating the replica. This means high possibility of infringement of the electronic work.

In a method of protecting the copyrights of such electronic works, a work is ciphered for circulation, and data which is necessary for decoding the work is issued to only persons who have a consent for utilizing the work. When this method is used, even if the ciphered work is duplicated by a person having no right to do so without any permission, it does not substantially lead to any copyright infringement unless the ciphered work is decoded.

Among prior art work reproducing systems for protecting the copyrights of works, are a method exemplified as prior art in FIGS. 16 and 17 of Japanese Patent Laid-Open No. 10-283270 (hereinafter referred to as first prior art) and a method disclosed as Embodiment 2 in FIGS. 7 to 11 of Japanese Patent Laid-Open No. 10-283270 (hereinafter referred to as second prior art).

FIG. 22 shows ciphered contents stored in a recording medium and a procedure of generating a code of consent for utilizing the contents in the first and second prior arts.

As shown, a first ciphering means 803 ciphers contents 801 with ciphering keys 802 to generate ciphered contents 804. The ciphered contents 804 are stored in a recording medium 805. The ciphering keys 802 are determined by a given means by the copyright owner. A second ciphering means 807 ciphers the ciphering keys 802 with first peculiar data 806 as ciphering keys to generate a first consent code 808. In the first prior art, the first consent code 808 is preserved by the copyright owner or stored in a non-rewritable area of the recording medium 805. In the second prior art, the code 808 is stored in the non-rewritable area of the recording medium 805. In the first prior art, the first peculiar data 806 is stored in the recording medium 805 as data peculiar thereto. In the second prior art, the data 806 is data peculiar to a recording medium drive and is stored in a storing means therein.

Now, the procedure of decoding the ciphered contents 804 stored in the recording medium 805 will be described.

In the first prior art, the user first obtains the first consent code 808. Specifically, when the code 808 is preserved by the copyright owner, the user obtains the code 808 from the copyright owner. When the code 808 is stored in the non-rewritable area of the recording medium 805, the user obtains the code 808 by reading out the code 808 from the medium 805. The user then reads out the first peculiar data 806 peculiar to the medium 805 from the medium 805, and deciphers the codes 808 with the first peculiar data 806 as ciphering keys to obtain the ciphering keys 802. Finally, the user deciphers the ciphered contents 804 stored in the recording medium 805 with the ciphering keys 802 to obtain the contents 801.

In the second prior art, when first utilizing the contents 801, a first consent code is produced by using the first peculiar data 806 and second peculiar data as will be described later in detail. When utilizing the contents 801 for the second and following times, the user obtains the contents 801 by using such a method that the second consent code is substituted for the first consent code 808 and that the second peculiar data is substituted for the first peculiar data 806. More specifically, the user obtains the ciphering keys 802 from the second consent code and the second peculiar data, and then obtains the contents 801 from the ciphering keys 802 and the ciphered contents 804. As shown, the procedure of utilizing the contents 801 for the second and following times is substantially the same as in the first prior art, and thus it is not described in further detail. The procedure of generating the second peculiar data when utilizing the content 801 for the first time will now be described.

FIG. 23 illustrates the procedure of generating the second consent code when the user first utilizing the contents in the second prior art.

First, the user causes the first consent code 901 read out from the recording medium to be decoded in a decoding means 903 with the first peculiar data 902 peculiar to the drive as ciphering keys to obtain the ciphering keys 904. The ciphering keys 904 are the same as the ciphering keys 802 shown in FIG. 22. The user then causes the ciphering keys 904 to be ciphered in a third ciphering means 906 with the second peculiar data 905 as ciphering keys to obtain the second consent code 907.

The decoding means 903 corresponds to the second ciphering means 807 shown in FIG. 22, and the second ciphering mean 807 and the decoding means 903 should be such as to provide inverse functions to each other, respectively, under the same ciphering keys. The third ciphering means 906 is usually the same as the second ciphering means 807 in FIG. 22. However, it is also possible to use a different ciphering means. When such a different ciphering means is used, the decoding of the ciphering keys 802 when utilizing the contents for the second and following times, requires the use of a decoding means corresponding to the third ciphering means 906. In the second prior art, i.e., according to an eighth invention disclosed in the Japanese Patent Laid-Open No. 10-283270, the second peculiar data 905 is data peculiar to the recording medium, according to a ninth invention it is data peculiar to the user, and according to a tenth invention it is data peculiar to a computer for controlling the drive.

Finally, the effects of the above prior arts will be described.

In the first prior art, the first peculiar data 806 used for generating the first consent code 808 is data peculiar to the recording medium 805, and it is thus possible to obtain an effect that it is possible to prevent the ciphered contents 804 from being unfairly copied in a separate recording medium having different peculiar data and utilized.

In the second prior art, the first consent data 808 is independent of the recording medium 805, and it is thus possible to solve the problem that different data each stored in each independent recording medium 805 in the first prior art leads to increase of the cost of manufacture of the medium 805. In addition, the second peculiar data 905 is dependent on the recording medium, the user or the computer, and it is thus possible to prevent unfair copying and utilization of the ciphered contents 804 independently of the recording medium, the user of the computer having the same peculiar data.

In the first prior art, the first peculiar data is peculiar to a recording medium, in which ciphered contents are stored. In the second prior art, contents utilization data for checking whether contents have been utilized or not should be recorded in a recording medium, in which the contents are stored. Therefore, in either of the first and second prior arts, the ciphered contents should be stored for circulation in a recording medium having a physical substance. That is, a problem is posed that the ciphered contents cannot be circulated via an internet system or like means.

In addition, in the first and second prior arts a recording medium is necessary when utilizing contents therein in the case of second peculiar data which is peculiar to that recording medium. That is, a problem is posed that the contents cannot be stored for utilization in a separate recording medium, such as a hard disc belonging to the system for utilizing the contents.

Furthermore, in the second prior art, if the second peculiar data is peculiar to the user and the user has a regularly received contents utilization consent by the copyright owner, once the user circulates his or her own second consent code and second peculiar data to a third party, it becomes possible for the third party to utilize the contents even without any contents utilization consent. That is, a problem is posed that the copyright may not be sufficiently protected.

Still further, in the second prior art, if the second peculiar data is data peculiar to a drive control computer, even a user who has regularly received a contents utilization consent can not utilize the contents with a different system not controlled by the computer. That is, a problem is posed that a user who desires to utilize the contents with a plurality of different systems, has to receive a contents utilization consent for each system.

Yet further, in the first and second prior arts, once the user obtains the contents utilization code, he or she can utilize the contents without any restriction. That is, a problem is posed that it is difficult to adopt a more sophisticated contents utilization consent rendering method (such as one in which a consent for utilizing the contents only for a predetermined number of times can be given, or one in which a consent for utilizing only a particular function can be given).

### SUMMARY OF THE INVENTION

An object of the present invention is to provide a work reproducing system, a work decoding system and a user's peculiar data storing system, which permit circulation of works without any particular recording medium while ensuring copyright protection.

Another object of the present invention is to provide a work reproducing system, a work decoding system and a user's peculiar data storing system, which permit reconstruction of works without need of recording media used for the circulation of the works while ensuring copyright protection.

A further object of the present invention is to provide a work reproducing system, a work decoding system and a user's peculiar data storing system, which make it difficult for a third party, to which a user having a regularly received consent of decoding a work has circulated data received as a proof of the decoding consent, to decipher the work and infringe the copyright thereof.

A still further object of the present invention is to provide a work reproducing system, a work decoding system and a user's peculiar data storing system, which permit a user desiring to decipher a work with a plurality of different systems to do so without need of receiving a decoding consent for each of the systems.

A yet further object of the present invention is to provide a work reproducing system, a work decoding system and a user's peculiar data storing system, which permit realizing a more sophisticated work decoding consent rendering method.

Work reproducing system according to a first invention is a work reproducing system for reproducing a work capable of being coded by an electronic means; the work being coded such as to be decoded with user's peculiar data preliminarily assigned to a particular user; the work reproducing system comprising a work decoding system including a decoding means for decoding the coded work with the user's peculiar data, a user's peculiar data storing system capable of being detachably mounted in the work decoding system, and a communicating means for communicating with the user's peculiar data storing system; the user's peculiar data storing system including a communicating means for communicating with the work decoding system, and a storing means for storing the user's peculiar data necessary for decoding the coded work; the user's peculiar data being transmitted from the user's peculiar data storing system to the work decoding system, and the coded work being decoded in the work decoding system with the user's peculiar data.

Work reproducing system according to a second invention features in that in the first invention the work decoding system transmits the work as a result of decoding of the coded work to a reproducing system including a reproducing means for reproducing the work, the work being reproduced in the reproducing system.

Work reproducing system according to a third invention features in that in the first or second invention the work decoding system includes a reproducing means for reproducing the work, the work as a result of decoding of the coded work being reproduced in the work decoding system.

Work reproducing system according to a fourth invention features in that in one of the first to third invention which further comprises a work distributing system including a communicating means for transmitting the coded work, the work decoding system including a coded work storing means for storing the coded work and a communicating means for communicating with the work distributing means, the work decoding system obtaining the coded work by communication with the work distributing system.

Work reproducing system according to a fifth invention features in that in one of the first to fourth invention, which further comprises a work distributing system including a communicating means for transmitting the coded work, and a communicating system including a communicating means for communicating the work distributing system, the work decoding system including a communicating means for communicating with the communicating system, the work decoding system obtaining the coded work by communication with the work distributing system via the communicating system.

Work reproducing system according to a sixth invention features in that in one of the first to fifth invention, which comprises a work storing system capable of being detachably mounted in the work decoding system and including a storing means for storing the coded work and a communicating means for communicating with the work decoding system, the work decoding system including a communicating means for communicating with the work storing system, the work decoding system obtaining the coded work by communicating with the work storing system.

By adopting this constitution, since the coded work is obtained by coding with the user's peculiar data, a person who does not have the user's peculiar data cannot decode the coded work, and it is thus possible to provide copyright protection.

In addition, the coding does not depend on any particular recording medium, that is, no particular recording medium is needed at the time of the decoding, and it is thus possible to realize distribution and reproduction of a work not requiring any particular recording medium.

Furthermore, since the user's peculiar data necessary for decoding a coded work is stored in a particular user's peculiar data storing system, it is difficult for the user to unfairly distribute regular user's peculiar data to a third party and thus let the third party to decode the coded work.

Still further, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems.

Work reproducing system according to a seventh invention features in that in one of the first to sixth invention, the user's peculiar data storing system includes a storing means for storing work management data for checking whether a user as owner of the user's peculiar data storing system has a consent for decoding each coded work, and in a situation that the coded work is to be decoded with the user's peculiar data storing system connected to the work decoding system, by referring the work management data the coded work is decoded when and only when it is decided that the user has a consent for decoding the coded work.

Work reproducing system according to an eighth invention features in that in the seventh invention, the user's peculiar data storing system includes a communicating means for communicating with a center for producing work management data, the user's peculiar data storing system obtaining work management data from the center by communicating with the center.

Work reproducing system according to a ninth invention features in that in the seventh or eighth invention work reproducing system, the work decoding system transmits work decoding result data to the user's peculiar data storing system according to the decoding of the coded work, the user's peculiar data storing system including an updating means for updating work management data stored in it according to the work decoding result.

Work reproducing system according to a tenth invention features in that in the eighth or ninth invention, the user's peculiar data storing system includes a communicating means for communicating with a center for producing work management data, the user's peculiar data storing system updates work management data stored therein according to work management data updating data received from the center.

Work reproducing system according to an eleventh invention features in that in the tenth invention, the user's peculiar data storing system includes a storing means for storing work decoding result data, stored work decoding result data being transmitted via a communicating means for communicating with the center to the center.

By adopting this constitution, the similar advantages of one of the first to sixth inventions are obtainable. More specifically, since the coded work is obtained by coding with the user's peculiar data, a person who does not have the user's peculiar data cannot decode the coded work, and it is thus possible to provide copyright protection. In addition, the coding does not depend on any particular recording medium, that is, no particular recording medium is needed at the time of the decoding, and it is thus possible to realize distribution and reproduction of a work not requiring any particular recording medium. Furthermore, since user's peculiar data necessary for decoding a coded work is stored in a particular user's peculiar data storing system, it is difficult for the user to unfairly distribute regular user's peculiar data to a third party and thus let the third party to decode the coded work. Still further, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems.

The work reproducing system according to the seventh invention, provides a function of managing more sophisticated coded work decoding consent conditions set under agreement of the copyright owner and the user by storing work management data in the user's peculiar data storing system.

The work reproducing system according to the eighth invention, provides a function that the user's peculiar data storing system obtains work management data concerning a coded work, which the user has a newly obtained consent for decoding, by receiving the work management data from the center.

The work reproducing system according to the ninth invention, provides a function of updating the work management data according to a work decoding result and thus managing the residual number of times of consent decoding of the coded work.

The work reproducing system according to the tenth invention, provides a function that the user's peculiar data storing system updates coded work decoding consent conditions by receiving work management data updating data from the center. For instance, such a function is provided that the user is permitted to update the restriction on the coding of a coded work or provides an additional residual consent number of times of consent decoding of the coded work.

The work reproducing system according to the eleventh invention, provides a function that the user's peculiar data storing system transmits work decoding result data to the center, so that when the coded work decoding consent conditions are such that fees are to be paid according to the work decoding result, the center calculates the fee by collecting the work decoding result data.

Work decoding system according to the twelfth invention features is a work decoding system for decoding a coded work whiv is coded by an electronic means with user's peculiar data preliminarily assigned to a particular user, comprising: a first connecting means for being connected to a user's peculiar data storing system for storing the user's peculiar data; a first communicating means for communicating with the user's peculiar data storing means with the first connecting means connected thereto; a coded work storing means for storing the coded work; a decoding means for receiving the coded work stored in the coded work storing means and user's peculiar data obtained from the user's peculiar data storing means via the first connecting means in the first communicating means and decoding the coded work.

Work decoding system according to the thirteenth invention features in that which further comprises a second communicating means for feeding out the decoded work obtained by decoding in the decoding means to the outside.

Work decoding system according to the fourteenth invention in the twelfth or thirteenth invention, which further comprises a reproducing means for reproducing the decoded work obtained by decoding in the decoding means.

Work decoding system according to the fifteenth invention features in that in the twelfth or fourteenth invention, which further comprises a third communicating means for storing the coded work and communicating with a work distributing system.

Work decoding system according to the sixteenth invention features in that in one of the twelfth to fifteenth invention, which further comprises a fourth communicating means for communicating with a communicating system including as communicating means for communicating with a work distributing system for storing and transmitting the coded work.

Work decoding system according to the seventeenth invention features in that in one of the twelfth to sixteenth invention, which further comprises a second connecting means of being connected to a work storing system including a storing means for storing the coded work and a fifth communicating means for communicating with the work storing system.

By adopting this constitution, the coded work is coded with the user's peculiar data, and a person not having the user's peculiar data cannot decode the coded work. Thus, it is possible to provide copyright protection.

In addition, the coding does not depend on any particular recording medium, that is, no particular data is needed at the time of the decoding. The work decoding system thus can receive and decode the coded work without need of any particular recording medium.

Furthermore for decoding the coded work, a user's peculiar data storing system with regular user's peculiar data stored therein should be connected to the work decoding system. Thus, it is difficult for the user to unfairly distribute regular user's peculiar data to the third party and let the third party to decode the coded work.

Still further, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems.

Work decoding system according to the eighteenth invention features in that in one of the twelfth to seventeenth invention when the coded work is to be decoded, work attribute data pertaining to the coded work is transmitted via the first communicating means to the user's peculiar data storing system.

Work decoding system according to the ninteenth invention features in that in the eighteenth invention, work management data stored in the user's peculiar data storing system as data for checking whether a consent for decoding the coded work is present is obtained from the user's peculiar data storing system via the first communicating means and is referred to in a check as to whether the user has a consent for decoding the coded work, and when and only when it is decided that the user has the consent for decoding the coded work is decoded in the decoding means.

Work decoding system according to the twentieth invention features in that in one of the twelfth to ninteenth invention, which further comprises a work decoding result producing means for converting the history of decoding in the decoding means as a work decoding result to data capable of being processed in the user's peculiar data storing system, and a communicating means for transmitting the work decoding result via the first communicating means to the user's peculiar data storing system.

By adopting this constitution, the similar advantages of the twelfth to seventeenth inventions are obtainable. More specifically, since the coded work is obtained by coding with the user's peculiar data, a person who does not have the, user's peculiar data cannot decode the coded work, and it is thus possible to provide copyright protection. In addition, the coding does not depend on any particular recording medium, that is, no particular recording medium is needed at the time of the decoding, and it is thus possible to realize distribution and reproduction of a work not requiring any particular recording medium. Also, for decoding a coded work, a user's peculiar data storing system with regular user's data storing system should be connected to the work decoding system. Thus, it is difficult for the user to unfairly distribute the regular user's peculiar data to the third party and let the third party to decode the coded work. Furthermore, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems. It is thus possible to provide a more sophisticated method of giving a coded work decoding consent.

More specifically, in the work decoding system according to the eighteenth invention, by transmitting work attribute data of a coded work to be decoded to the user's peculiar data storing system for storing work management data it is made possible to collate more sophisticated coded work decoding consent conditions set under agreement of the copyright owner and the user and work attribute data with each other. It is thus possible to provide a more sophisticated method of giving a coded work decoding consent.

In the work decoding system according to the nineteenth invention, it is possible to provide a more sophisticated method of giving a coded work decoding consent by collating work management data concerning the coded work to be decoded.

In the word decoding system according to the twentieth invention, it is possible to charge fees according to a work decoding result in such a manner as transmitting the word decoding result to the user's peculiar data storing system and causing the user's peculiar data storing system to update the work management data or transmit the work decoding result data to the center.

User's peculiar data storing system according to the twenty-first invention features in that which comprises: a first storing means for storing the user's peculiar data; a connecting means for connecting the user's peculiar data storing system to a work decoding system; and a first communicating means for communicating with the work decoding system.

By adopting this constitution, since the user's peculiar data necessary for decoding the coded work is stored in the user's peculiar data storing system, it is difficult for the user to unfairly distribute regular user's peculiar data to the third party and let the third party to decode the coded work.

In addition, since the user's peculiar data storing system includes the connecting means for connecting it to the work decoding system and is capable of being detachably mounted in the work decoding system, even a user who uses a plurality of different work decoding systems can decode a coded work in a desired one of his or her work decoding systems by connecting the user's peculiar data storing system to that work decoding system. It is thus possible to decode a coded work without need of obtaining a coded work decoding consent for each of the plurality of work decoding systems.

User's peculiar data storing system according to the twenty-second invention features in that in the twenty-first invention which further comprises a second storing means for storing work management data for checking whether a consent for decoding each coded work to be decoded in the work decoding system is present, and a checking means for checking whether a consent for decoding a coded work is present when the coded work is to be decoded in the work decoding system.

User's peculiar data storing system according to the twenty-third invention features in the twenty-first invention which further comprises a second storing means for storing work management data for checking whether a consent for decoding each coded work to be decoded in the work decoding system is present, work management data concerning a coded work being transmitted via the first communicating means to the work decoding system when the coded work is to be decoded in the work decoding system.

By adopting this constitution, the similar advantages of the twenty-first invention are obtainable. More specifically, since the user's peculiar data necessary for decoding a coded work is stored in a particular user's peculiar data storing system, it is difficult for the user to unfairly distribute regular user's peculiar data to a third party and thus let the third party to decode the coded work. Still further, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems. It is thus possible to provide a more sophisticated method of giving a coded work decoding consent.

More specifically, in the user's peculiar data storing system according to the twenty-second invention, a check as to whether a coded work decoding consent is present is executed according to the work management data. Thus, it is possible to allow the user having the user's peculiar data storing system to decode the coded work by transmitting the user's peculiar data necessary for decoding the coded work to the work decoding system only when the user has a consent for decoding the coded work.

In the user's peculiar data storing system according to the twenty-third invention, it is possible to the user having the user's peculiar data storing system to execute a check as to whether a consent for decoding a coded work is present by transmitting work attribute data pertaining to the coded work to the work decoding system.

User's peculiar data storing system according to the twenty-fourth invention features in that in the twenty-second or twenty-third invention, which comprises a second communicating means for communicating with a center for producing the work management data, work management data being obtained from the center via the second communicating means.

By adopting this constitution, the similar advantages of the twenty-second or twenty-third invention are obtainable. More specifically, since the user's peculiar data necessary for decoding a coded work is stored in a particular user's peculiar data storing system, it is difficult for the user to unfairly distribute regular user's peculiar data to a third party and thus let the third party to decode the coded work. Still further, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems. It is possible for a user with the user's peculiar data only when the user has the consent of decoding the coded work by checking whether the acceptance of decoding the coded work in the user's peculiar data storing system or work decoding system on the basis of the work management data. Also, by providing the communicating means for receiving work management data from the center by communication therewith, it is possible to permit new setting of coded work decoding consent conditions, which have not been set at the time of connection of the user's peculiar data storing system. Thus, a more sophisticated work decoding consent giving method is provided.

User's peculiar data storing system according to the twenty-fifth invention features in that in one of the twenty-second to twenty-fourth invention which comprises a communicating means for receiving work decoding result data from the work decoding system, a third storing means for storing the work decoding result data, and an updating means for updating the work management data stored in the second storing means according to the work decoding result.

By adopting this constitution, the similar advantages of one of the first to sixth inventions are obtainable. More specifically, since the user's peculiar data necessary for decoding a coded work is stored in a particular user's peculiar data storing system, it is difficult for the user to unfairly distribute regular user's peculiar data to a third party and thus let the third party to decode the coded work. Since the user's peculiar data storing system includes the connecting means or connecting it and can be connected to the work decoding system, even a user who uses a plurality of different work decoding systems, can decode by connecting that work decoding system, and can also decode a coded work without need of obtaining a coded work decoding consent for each of the work decoding systems. Furthermore, with the user's peculiar data storing system or the work decoding system adapted to execute a check according to the work management data as to whether a coded work decoding consent is present, it is possible to allow the user having the user's peculiar data storing system to decode a coded work when and only when the user has a consent or decoding the coded work. Still further, by providing the communicating means for receiving the work management data from the center by communication therewith, it is possible to permit new setting of coded work decoding consent conditions, which have not been set at the time of connection of the user's peculiar data storing system. It is thus possible to provide a more sophisticated coded work decoding consent giving method. Yet further, by causing updating of the work management data according to a work decoding result, it is possible to let a consent for decoding a coded work no more than a predetermined number of times, thus realizing a more sophisticated coded work decoding consent method.

User's peculiar data storing system according to the twenty-sixth invention features in that in the twenty-fourth or twenty-fifth invention, which comprises a second communicating means for communicating with a center for producing the work management data, and an updating means for updating the work management data stored in the second storing means, the updating means updating the work management data according to work management data updating data received from the center.

By adopting this constitution, the similar advantages of one of the first to sixth inventions are obtainable. More specifically, since the user's peculiar data necessary for decoding a coded work is stored in a particular user's peculiar data storing system, it is difficult for the user to unfairly distribute regular user's peculiar data to a third party and thus let the third party to decode the coded work. Still further, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems. It is possible for a user with the user's peculiar data only when the user has the consent of decoding the coded work by checking whether the acceptance of decoding the coded work in the user's peculiar data storing system or work decoding system on the basis of the work management data. Also, by permitting updating of the work management data according to the work decoding result, it is possible to give a consent for decoding a coded work only no more than a predetermined number of times. Furthermore, by providing the updating means for updating the work management data according to the work management data updating data received from the center, it is possible to increase a preset consent number of times of decoding a coded work by updating preset coded work decoding consent conditions. It is thus possible to provide a more sophisticated coded work decoding consent giving method.

User's peculiar data storing system according to the twenty-seventh invention features in that in the twenty-sixth invention, which comprises a communicating means for transmitting work decoding result data stored in the third storing means to a center for producing the work management data.

By adopting this constitution, the similar advantages of one of the first to sixth inventions are obtainable. More specifically, since user's peculiar data necessary for decoding a coded work is stored in a particular user's peculiar data storing system, it is difficult for the user to unfairly distribute regular user's peculiar data to a third party and thus let the third party to decode the coded work. Still further, since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems. It is possible for a user with the user's peculiar data only when the user has the consent of decoding the coded work by checking whether the acceptance of decoding the coded work in the user's peculiar data storing system or work decoding system on the basis of the work management data. By providing the communicating means for receiving the work management data from the center by communication therewith, it is possible to permit newly setting coded work decoding consent conditions, which have not been set at the time of connection of the user's peculiar data storing system. It is thus possible to provide a more sophisticated coded work decoding consent giving method. Furthermore, by permitting updating of the work management data according to the work decoding result, it is possible to give a consent for decoding a coded work in no more than a predetermined times. Still further, by providing the updating means for updating the work management data according to the work management data updating data received from the center, it is possible to increase a preset consent number of times of decoding of a coded work. It is thus possible to provide a more sophisticated coded work decoding consent giving method. Yet further, by transmitting the work decoding result to the center by using the user's peculiar data storing system, it is possible to charge fees to the user according to the work decoding result or determine the proportion of the free recovered from the user to the copyright owner. By providing such means it is possible to provide a more sophisticated coded work decoding consent giving method.

A recording medium according to the twenty-eighth invention features in a recording medium with a record therein of programs for causing a computer to execute a procedure of obtaining user's peculiar data from a user's peculiar data storing system, procedure of obtaining a coded work from a coded work storing means, and a procedure of decoding the coded work with the user's peculiar data.

A recording medium according to the twenty-ninthh invention features in that a recording medium with a record therein of programs for causing a computer to execute a procedure of obtaining user's peculiar data from a user's peculiar data storing system, a procedure of obtaining a coded work from a coded work storing means, a procedure of decoding the coded work with the user's peculiar data, and procedure of producing the decoded work in a reproducing means.

A recording medium according to the thirtieth invention features in that a recording medium with a record therein of programs for causing a computer to execute a procedure of down-loading coded work from a work distributing system in a coded work storing means, a procedure of obtaining user's peculiar data from a user's peculiar data storing system, a procedure of obtaining a coded work from a coded work storing means, and a procedure of decoding the coded work with the user's peculiar data.

A recording medium according to the thirty-first invention features in a recording medium with a record therein of programs for causing a computer to execute a procedure of transmitting work attribute data from a coded work storing means to a user's peculiar data storing system, a procedure of obtaining user's peculiar data from the user's peculiar data storing system, a procedure of obtaining a coded work from the coded work storing means, and a procedure of decoding the coded work with the user's peculiar data.

A recording medium according to the thirty-second invention features in a recording medium with a record therein of programs for causing a computer to execute a procedure of transmitting work attribute data from a coded work storing means to a user's peculiar data storing system, a procedure of receiving the work management data from the user's peculiar data storing system, a procedure of checking whether the coded work stored in the coded work storing means can be decoded on the basis of the work management data, a procedure of obtaining user's peculiar data when the coded work can be decoded, a procedure of obtaining the coded work from the coded work storing means, and a procedure of decoding the coded work with the user's peculiar data.

A recording medium according to the thirty-third invention features in that a recording medium with a record therein of programs for causing a computer to execute a procedure of transmitting work attribute data from a coded work storing means to a user's peculiar data storing system, a procedure of receiving the work management data from the user's peculiar data storing system, a procedure of checking whether the coded work stored in the coded work storing means can be decoded on the basis of the work management data, a procedure of obtaining user's peculiar data when the coded work can be decoded, a procedure of obtaining the coded work from the coded work storing means, and a procedure of decoding the coded work with the user's peculiar data.

A recording medium according to the thirty-fourth invention features in that a recording medium with a record therein of programs for causing a computer to execute a procedure of transmitting work attribute data from a coded work storing means to a user's peculiar data storing system, a procedure of checking whether user's peculiar data could have been received from the user's peculiar data storing system, a procedure of obtaining user's peculiar data when the user's peculiar data could have been received, a procedure of obtaining the coded work form the coded work storing means, and a procedure of decoding the coded work with the user's peculiar data.

A recording medium according to the thirty-fifth invention features in that with a recording medium with a record therein of programs for causing a computer to execute a program of transmitting work attribute data from a coded work storing means to a user's peculiar data storing system, a procedure of obtaining user's peculiar data from the user's peculiar data storing system, a procedure of obtaining the coded work from the coded work storing means, a procedure of decoding the coded work with the user's peculiar data, a procedure of producing the work decoding result, and a procedure of transmitting work decoding result data to the user's peculiar data storing system.

Other objects and features will be clarified from the following description with reference to attached drawings.

### BRIEF DESCRIPTION OF THE DRAWINGS

FIG. 1 is a block diagram showing a first embodiment of the work reproducing system according to the present invention;

FIG. 2 is a flow chart showing the operation of the first embodiment of the work reproducing system;

FIG. 3 is a block diagram showing a second embodiment of the work reproducing system according to the present invention;

FIG. 4 is a flow chart showing the operation of the second embodiment of the work reproducing system;

FIG. 5 is a block diagram showing a third embodiment of the work reproducing system according to the present invention;

FIG. 6 is a flow chart showing the operation of the third embodiment of the work reproducing system;

FIG. 7 is a block diagram showing a fourth embodiment of the work reproducing system according to the present invention;

FIG. 8 is a flow chart showing the operation of the fourth embodiment of the work reproducing system;

FIG. 9 is a block diagram showing a fifth embodiment of the work reproducing system according to the present invention;

FIG. 10 is a flow chart showing the operation of the fifth embodiment of the work reproducing system;

FIG. 11 is a block diagram showing a sixth embodiment of the work reproducing system according to the present invention;

FIG. 12 is a flow chart showing the operation of the sixth embodiment of the work reproducing system;

FIG. 13 is a block diagram showing a seventh embodiment of the work reproducing system according to the present invention;

FIG. 14 is a flow chart showing the operation of the seventh embodiment of the work reproducing system;

FIG. 15 is a block diagram showing an eighth embodiment of the work reproducing system according to the present invention;

FIG. 16 is a block diagram showing a ninth embodiment of the work reproducing system according to the present invention;

FIG. 17 is a block diagram showing a tenth embodiment of the work reproducing system according to the present invention;

FIG. 18 is a block diagram showing an eleventh embodiment of the work reproducing system according to the present invention;

FIG. 19 is a block diagram showing a twelfth embodiment of the work reproducing system according to the present invention;

FIG. 20 is a block diagram showing the thirteenth embodiment of the work reproducing system according to the present invention;

FIG. 21 is a block diagram showing a fourteenth embodiment of the work reproducing system according to the present invention;

FIG. 22 is a block diagram showing a first prior art; and

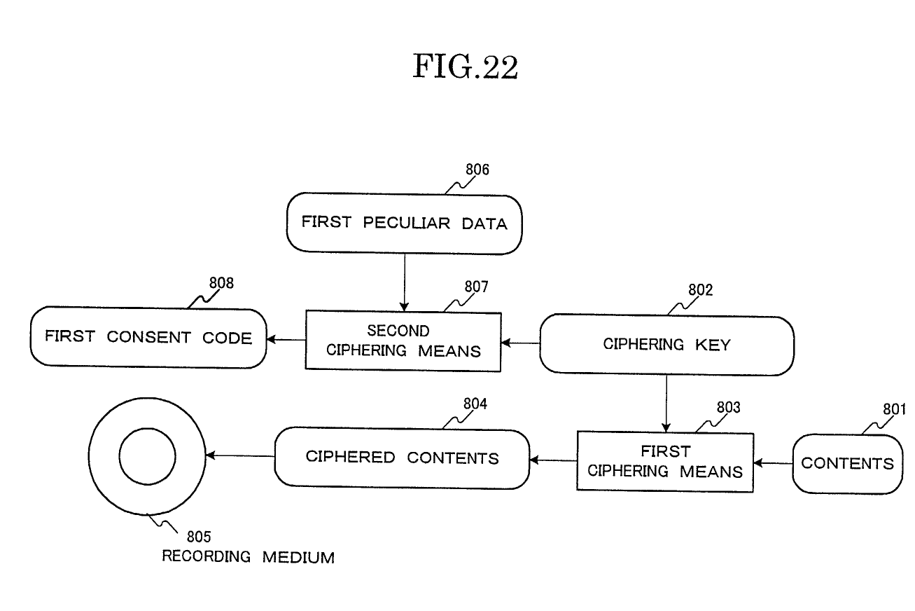

FIG. 23 is a block diagram showing a second prior art.

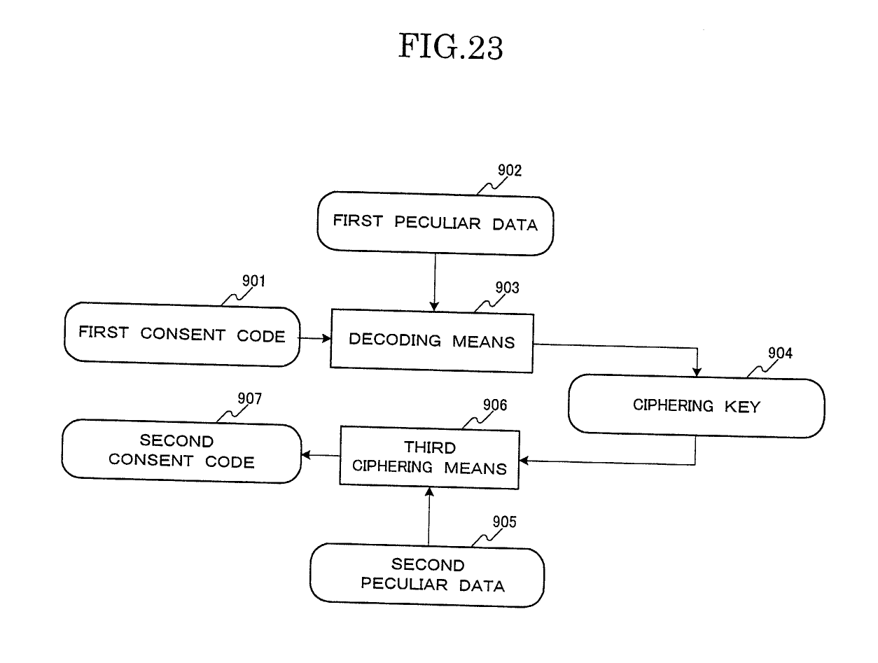

### PREFERRED EMBODIMENTS OF THE INVENTION

Preferred embodiments of the present invention will now be described with reference to the drawings.

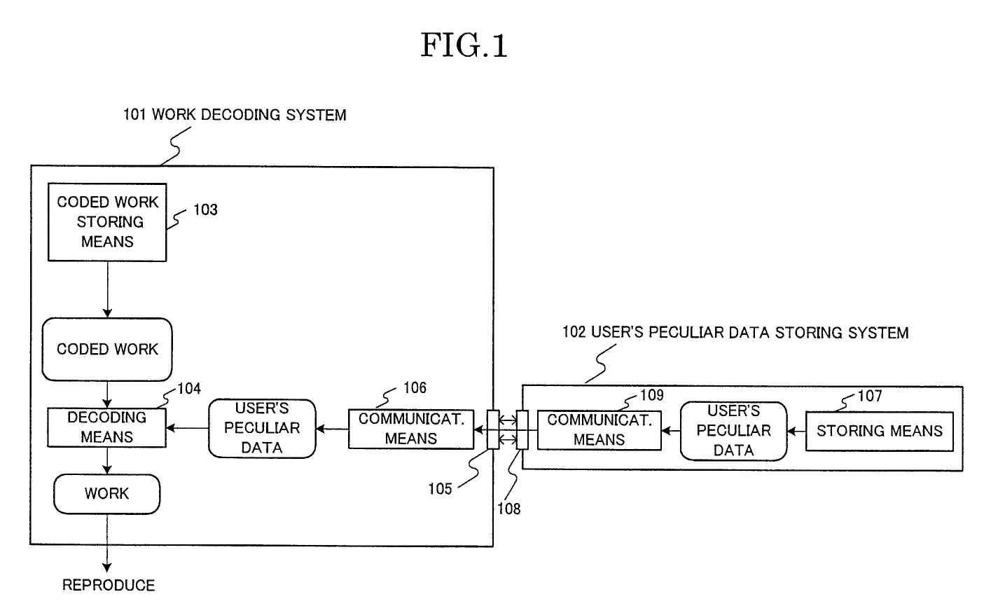

FIG. 1 is a block diagram showing a first embodiment of the work reproducing system according to the present invention.

The first embodiment of the work reproducing system is a work reproducing system according to a first invention, and comprises a work decoding system 101 according to a twelfth invention and a user's peculiar data storing system 102 according to a twenty-first invention.

The work decoding system 101 includes a ciphered work storing means 103 for storing a ciphered work, a decoding means 104, a connecting means 105 for connecting it to the user's peculiar data storing means 102, and a communicating means 106 for doing communication with the means 102. The system 101 may be a portable music player, a radio cassette, a car stereo set, and a video camera, a digital camera and a personal computer with a playback function, etc. It is assumed that these systems have a terminal or a slot for their connection to the user's peculiar data storing system 102 and, in some case, also have a terminal or a slot for their connection to a player or a work distributor, a CD drive, etc. The system 101 does not include any storing means for storing any decoded work, and reproduction of work is executed once when decoding is executed once. By the term “reproduction” is meant not only the playback of music and video, but a broader concept including the display of paintings, execution of programs, etc. is meant.

The user's peculiar data storing system 102 includes a storing means 107 for storing user's peculiar data, a connecting means 108 for connecting it to the work decoding system 101 and a communicating means for communication with the system 101. The system 102 may be a memory card such as a smart card, and it is connected to the system 101 via a terminal or a slot when decoding a ciphered work in the work decoding system 101 and reproducing the decoded work.

In addition to the ciphering, coding and decoding, involving compression, error correction coding, analog-to-digital conversion, etc., are executed appropriately in dependence on the nature of the work. The ciphering is an essential process. The decoding of a ciphered work requires user's peculiar data, and as for the method of ciphering and decoding the following three examples may be appropriately used.

A first example is a method of ciphering adopting a common ciphering key ciphering system. In this method, a coded work is obtained by ciphering a work with user's peculiar data used as ciphering keys. In the common ciphering key ciphering, the ciphering and decoding can be executed with the same ciphering keys. It is thus possible to decipher a coded work with the user's peculiar data. The ciphering is executed by the copyright owner himself or herself or requested to a third party. The person who executes the ciphering should have intelligence of the pertinent user's peculiar data. Such user's peculiar data is preliminarily registered in a pertinent center by the user or dispatched to the copyright owner. Usually, the former method is taken. When the data is registered in the center, the center serves as agency for ciphering the work.

A second example is a method adopting a laid-open ciphering key ciphering system. In this system, the ciphering keys for ciphering and those for decoding are different. In this example, the ciphering keys for decoding correspond to the user's peculiar data. The ciphering keys for ciphering are preliminarily registered in a pertinent center by the user or dispatched to the copyright owner. This method is different from the method adopting the common ciphering key ciphering system in that the ciphering keys for decoding cannot be readily obtained from those for ciphering. This means that it is possible to prevent the leakage of the user's peculiar data to a copyright owner, who cannot be trusted as such by all means. The user executes ciphering with ciphering keys to this end, which have been obtained directly from the user or obtained from the center as being pertinent to the user.

A third example is a method adopting both the common and laid-open ciphering key ciphering systems in combination. In this case, the copyright owner prepares ciphering keys for randomly ciphering a work, and uses these keys for ciphering the work in the common ciphering key ciphering system. Then, the copyright owner ciphers these keys with ciphering keys obtained as being those for the laid-open ciphering key ciphering pertinent to the user as in the second example. In this example, the ciphered work and the ciphered ciphering keys are thus prepared, and their combination corresponds to the coded work. In the decoding operation in the decoding means 104, the ciphering keys for ciphering the work are first restored by decoding what has been obtained by ciphering the ciphering keys with the user's peculiar data. The work is then decoded with ciphering keys for ciphering the restored work.

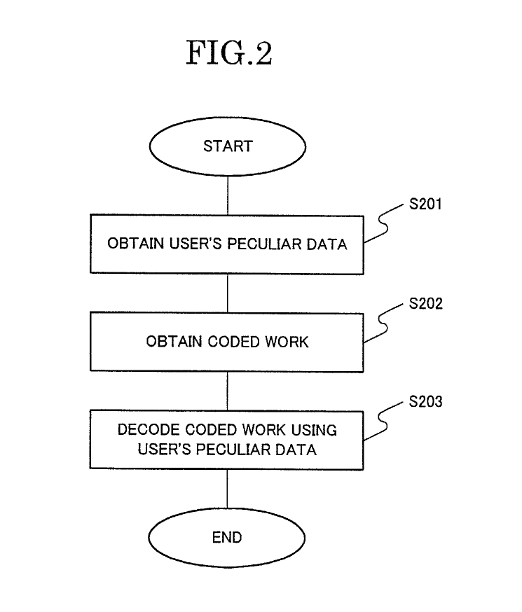

Referring to FIG. 2, the work decoding system 101 executes a process including a user's peculiar data obtaining step S201, a coded work obtaining step S202 and a coded work decoding step S203.

The operation of the first embodiment of the work reproducing system will now be described with reference to FIGS. 1 and 2.

It is assumed that a coded work is stored in the coded work storing means 103 such as to be capable of being decoded with user's peculiar data stored in the storing means 107. For decoding the coded work, the work decoding system 101 and the user's peculiar data storing system 102 are connected to each other via the connecting means 105 and 108. The two systems are connected by connecting their terminals, or by connecting a card and a slot or by using a cable.

Then, the user's peculiar data stored in the storing means 107 is fed out via the communicating means 109 and 106 to the decoding means 104 (step S201). Also, the coded work stored in the coded work storing means 103 is transmitted to the decoding means 104 (step S202). The decoding means 104 receives the user's peculiar data and the coded work, deciphers the coded work with the user's peculiar data, and reproduces the decoded work (step S203).

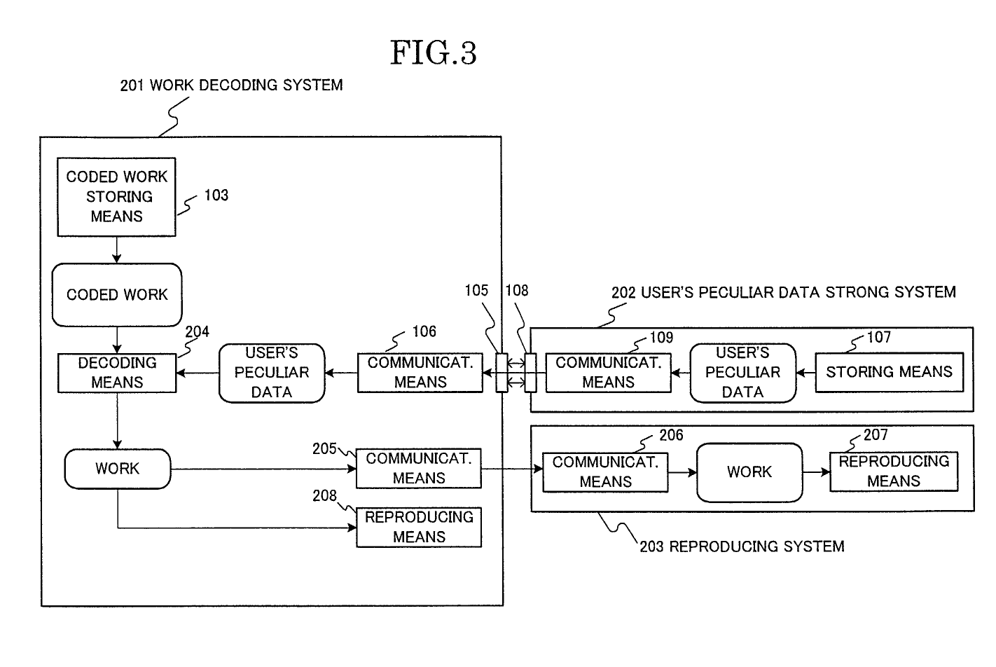

FIG. 3 is a block diagram showing a second embodiment of the work reproducing system according to the present invention.

The second embodiment of the work reproducing system is a work reproducing system according to the third invention, and comprises work decoding system 201 according to the fourteenth embodiment of the present invention, a user's peculiar data storing system 202 according to the twenty-first invention, and a reproducing system 203.

The second embodiment of the work reproducing system characterizes work reproducing systems according to the second and third aspects of the present invention and a work decoding system according to the thirteenth and fourteenth aspects of the present invention.

The work decoding system 201 includes, in addition to the work decoding system 101 according to the twelfth invention, a communicating means 205 for transmitting a work to the reproducing system 203, and a reproducing means 208 for reproducing the work.

The user's peculiar data storing system 202 is the same as the user's peculiar data storing system 102 in the first embodiment of the work reproducing system shown in FIG. 1.

The reproducing system 203 includes a communicating means 206 for receiving a work transmitted from the work decoding system 201 via the communicating means 205, and a reproducing means 207 for reproducing the received work. The system 203 may be a headphone, an external loudspeaker, a desk top personal computer display, etc.

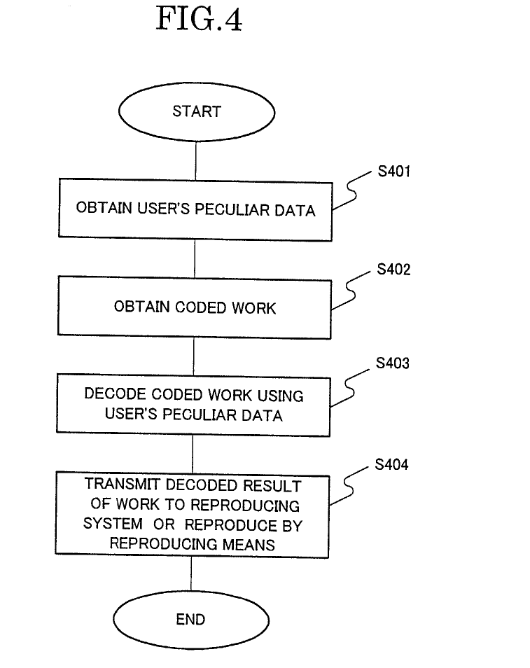

Referring to FIG. 4, the work decoding system 201 executes a process including a user's peculiar data obtaining step S401, a coded work obtaining step S402, a coded work decoding step S403 and a step S404 of transmitting or reproducing a work.

The operation of the second embodiment of the work reproducing system according to the present invention will now be described mainly in connection to the difference from the first embodiment of the work reproducing system with reference to FIGS. 3 and 4.

In the second embodiment of the work reproducing system, like the first embodiment of the work reproducing system, the decoding means 204 deciphers a coded work. More specifically, user's peculiar data stored in the storing means 107 is fed out via the communicating means 109 and 106 to the decoding means 204 (step S401). Also, a coded work stored in the coded work storing means 103 is fed out to the decoding means 204 (step S402). The decoding means 204 receiving the user's peculiar data and the coded work deciphers the coded work with the user's peculiar data (step S403). The decoded work is ready for being reproduced. Specifically, the work is transmitted via the communicating means 205 and 206 to the reproducing means 207 in the reproducing system 203 when it is intended to be reproduced thereon, while it is transmitted to the reproducing means 208 when it is intended to be reproduced in the work decoding system 201 (step S404).

Transmitting the work by the communicating means 205 via the communicating means 205 to the reproducing system 203 for reproduction, characterizes the work reproducing system according to the second invention. The communicating means 205 characterizes the work decoding system according to the thirteenth invention. Reproducing the work in the reproducing means 208, characterizes the work decoding system according to the third invention. The reproducing means 208 characterizes the work decoding system according to the fourteenth invention.

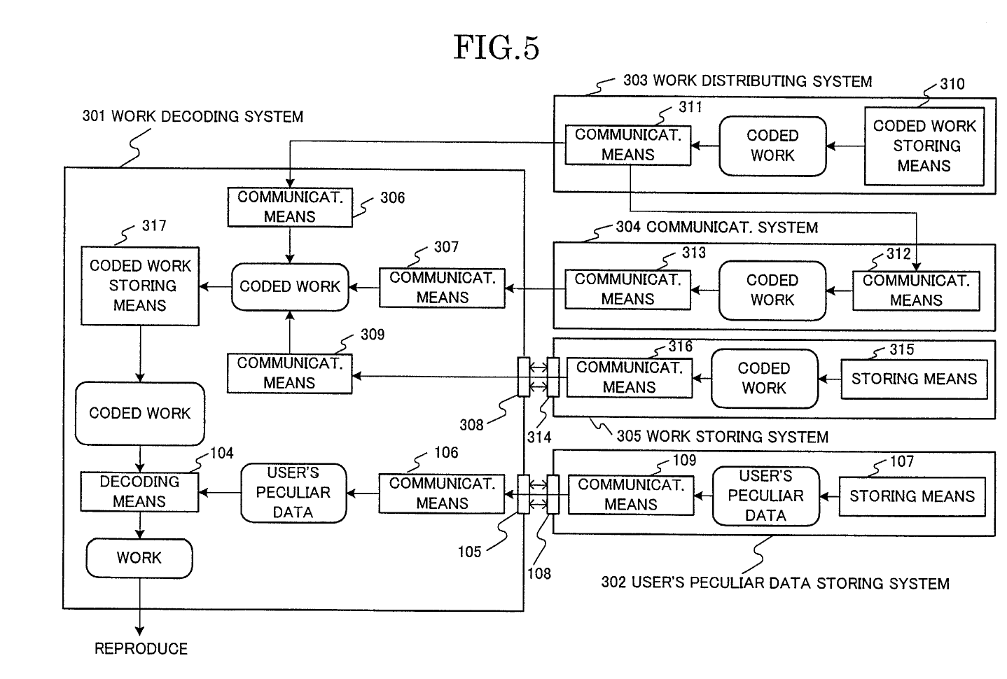

FIG. 5 is block diagram showing a third embodiment of the work reproducing system according to the present invention.

The third embodiment of the work reproducing system is a work reproducing system according to the sixth invention, and comprises a work decoding system 301 according to the seventeenth invention, a user's peculiar data storing system 302 according to the twenty-first invention, a work distributing system 303, a communicating system 304 and a work storing system 305.

The third embodiment of the work reproducing system characterizes work reproducing systems according to the fourth to sixth aspects of the present invention and also work decoding systems according to the fifteenth to seventeenth aspects of the present invention.

The work decoding system 301 includes, in addition to the work decoding system 101 according to the twelfth invention, a communicating means 306 for communicating with the work distributing system 303 to receive a coded work therefrom, a communicating means 307 for communicating with the communicating means 304 to receive a coded work therefrom, a communicating means 308 for connecting it to the work storing system 305, and a communicating means 309 for communicating therewith to receive the coded work therefrom.

The user's peculiar data storing system 302 is the same as the user's peculiar data storing means 102 in the first embodiment of the work reproducing system shown in FIG. 1.

The work distributing system 303 includes a coded work storing means 310 for storing a coded work, and a communicating means 311 for transmitting the coded work. The system 303 may be such a system as is installed in record shop as described above, and it can be directly connected to the work decoding system 301 for down-loading a coded work or the like therein.

The communicating system 304 includes a communicating means 312 for communicating with the work distributing system 303 for receiving a coded work therefrom, and a communicating means 313 for communicating with the work decoding system 301 to transmit a coded work thereto. The system 304 may be a personal computer connected to an internet system, a portable telephone set, etc., via which a coded work can be down-loaded in the work decoding system 301.

The work storing system 305 includes a connecting means 314 for connecting it to the work decoding system 301, a storing means 315 for storing a coded work, and a communicating means 316 for communicating with the work decoding system 301 to transmit a coded work thereto. The system 305 may be a floppy disc, a flash memory, etc. A coded work may be stored in the work storing means 305 by utilizing the system installed in the shop, the personal computer connected to the internet system, etc. as noted above. The work distributing system 303 is adapted to permit reproduction, i.e., decoding, of a work only in the work decoding system 301, to which the work is distributed. On the other hand, the work storing system 305 is adapted to permit decoding of a coded work in a plurality of separate work decoding systems so that, for instance, music stored in a cassette tape can be reproduced in a car stereo set, a portable music player, a radio cassette, etc.

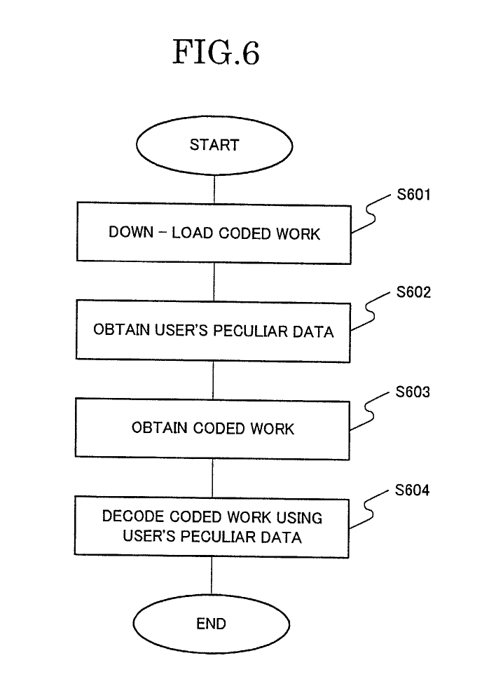

Referring to FIG. 6, the work decoding system 301 executes a process including a coded work down-loading step S601, a user's peculiar data obtaining step S602, a coded work obtaining step S603 and a coded work decoding step S604.

The operation of the third embodiment of the work reproducing system will now be described mainly in connection to the difference from the first embodiment of the work reproducing system with reference to FIGS. 5 and 6.

When it is intended to down-load a coded work stored in the work distributing system 303 directly in the work decoding system 301, the coded work stored in the coded work storing means 310 is down loaded via the communicating means 311 and 306 in the coded work storing means 317 (step S601).

When it is intended to down-load the coded work stored in the work distributing system 303 via the communicating system 304, the coded work stored in the coded work storing means 310 is first transmitted via the communicating means 311 and 312 to the communicating system 304 and then down-loaded via the communicating means 313 and 307 in the coded work storing means 317 (step S601).

When it is intended to down-load a coded work stored in the work storing system 305, first the work decoding system 301 and the work storing system 305 are connected to each other via the connecting means 308 and 314, and then the coded work stored in the storing means 315 is down-loaded via the communicating means 316 and 309 in the coded work storing means 317 (step S601).

The coded work stored in the coded work storing means 317 is reproduced in the same manner as in the first embodiment of the work reproducing system. More specifically, the user's peculiar data stored in the storing means 107 is transmitted via the communicating means 109 and 106 to the decoding means 104 (step S602). The coded work stored in the coded work storing means 317 is also transmitted to the decoding means 104 (step S603). The decoding means 104 receiving the user's peculiar data and the coded work deciphers the coded work with the user's peculiar data for reproducing the decoded work (step S604).

Down-loading the coded work stored in the work distributing system 303 via the communicating means 306 characterizes a work reproducing system according to the fourth invention. The communicating means 306 characterizes a word decoding system according to the fifteenth invention. Down-loading the coded work stored in the work distributing system 303 via the communicating system 304 and the communicating means 307, characterizes a work reproducing system according to the fifth invention. The communicating means 307 characterizes a work decoding system according to the sixteenth invention. Down-loading the coded work stored in the work storing system 305 via the communicating means 309 after connecting the work decoding system 301 to the work storing system 305 via the communicating means 308, characterizes a work reproducing system according to the sixth invention. The connecting means 308 and the communicating means 309 together characterize a work decoding system according to the seventeenth invention.

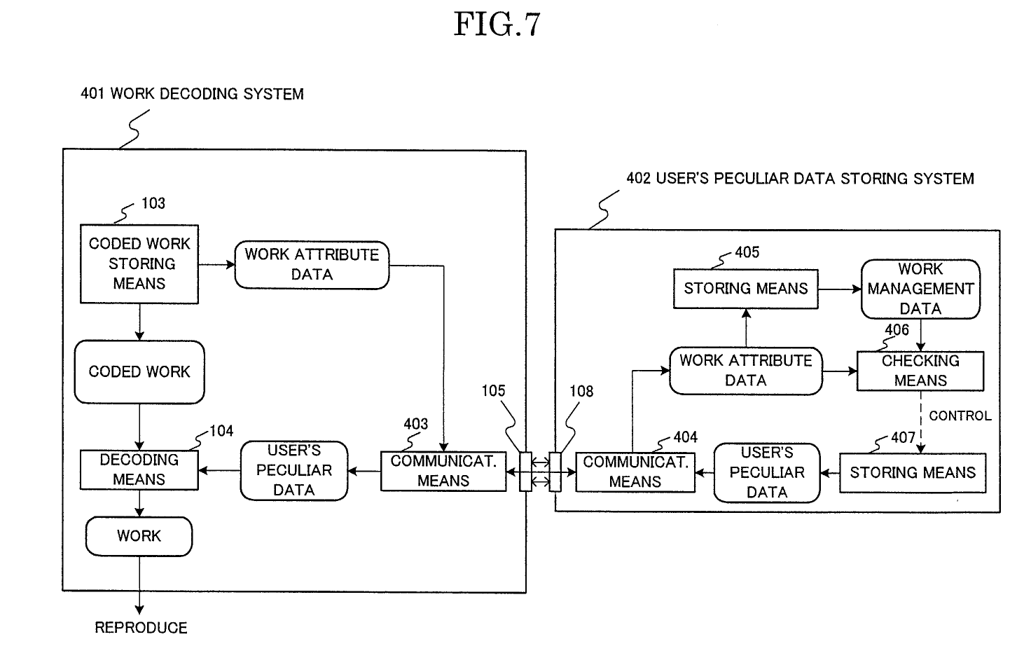

FIG. 7 is a block diagram showing a fourth embodiment of the work reproducing system according to the present invention.

The fourth embodiment of the work reproducing system is a work reproducing system according to the seventeenth invention, and comprises a work decoding system 401 according to the eighteenth invention, and a user's peculiar data storing system 402 according to the twenty-second invention.

According to claim 7, it is set forth that “the coded work is decoded only when it becomes clear with reference to the work management data that the user has a consent for decoding the coded work”. In the fourth embodiment of the work reproducing system, the user's data storing system 402 checks whether the user has the consent.

The work decoding system 401 is the same as the work decoding system 101 according to the twelfth invention except for that it also has a function of transmitting work attribute data of a coded work to be decoded via its communicating means 403 to the user's peculiar data storing system 402.

The user's peculiar data storing system 402 includes, in addition to the user's peculiar data storing system 102 according to the twenty-first invention, a communicating means 404 for receiving the work attribute data from the work decoding system 401, a storing means 405 for storing the work management data, and a checking means 406 for making a check with reference to the work management data stored in the storing means 405 and the received work attribute data as to whether the user has a consent for decoding the coded work.

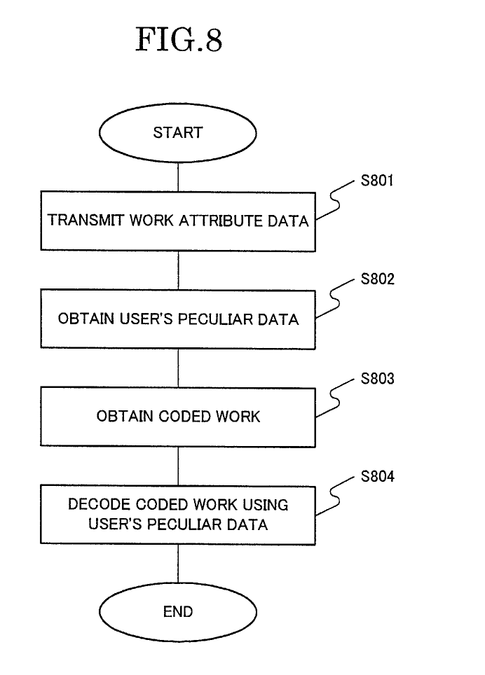

Referring to FIG. 8, the work decoding system 401 executes a process including a work attribute data transmitting step S801, a user's peculiar data obtaining step S802, a coded work obtaining step S803, and a coded work decoding step 804.

The operation of the fourth embodiment of the work reproducing system will now be described mainly in connection to the difference from the first embodiment of the work reproducing system with reference to FIGS. 7 and 8.

When it is intended to decipher a coded work stored in the work decoding system 401, the work attribute data corresponding to the coded work is transmitted via the communicating means 403 and 404 to the user's peculiar data string system 402 (step S801). By the term “work attribute data” is meant data specifying the work, such as the title of the work and a number peculiarity assigned to the work, and data related to the decoding of the work, such as the name of the work producer, the name of the copyright owner and requirements for the work decoding consent.

In the user's peculiar data storing system 402, what corresponds to the work attribute data among the work management data stored in the storing means 405, is transmitted to the checking means 406. By the term “work management data” is meant data including data about whether a consent for decoding a work having particular attribute data is present, such as data indicative of a consent for decoding a particular work or a work with a copyright belonging to a particular copyright owner.

Subsequently, the checking means 406 makes a check with reference to work management data and work attribute data pertaining to a coded work as to whether a consent for decoding the work is present.

By way of example, the work management data may include data indicative of that “work A is allowed to be reproduced”, that “work of Mr. B is allowed to be reproduced” and that “versions of computer program belonging to Series D by C company before Version E are allowed to be reproduced”, and the work attribute data may include those indicative of “name of work”, “name of work producer”, “version No.”, etc. In a work reproducing system according to the ninth invention, the work management data may include such contents as that “work A is allowed to be reproduced up to three times” and that “Series D is allowed to be reproduced up to 50 credits”, and the work attribute data may include such contents as that “3 credits are allowed in one time of reproduction”. The checking means 406 executes such an operation as referring to the work management data and the work attribute data and decides that reproduction is allowed when the contents of the work attribute data are that “work producer is Mr. B” and the contents of the work management data are that “work by Mr. B is allowed to be reproduced”. In the work reproducing system according to the ninth invention, when a work of such work attribute data as indicative of that “3 credits in Series D are allowed in one time of reproduction” is reproduced, the work management data is updated to be indicative of that “reproduction is allowed up to 47 credits”. The checking means 406, however, can also make a decision including such a numerical value processing that it is impossible to reproduce such a work as “3 credits are allowed in one time of reproduction” in such a situation that “reproduction is allowed up to 2 credits”.

When the checking means 406 fails to decide that a coded work is allowed to be reproduced, no user's peculiar data is transmitted, and the work decoding system 401 does not decipher any work for reproduction.

When the checking means 406 decides that a coded work is allowed to be decoded, as in the first embodiment of the work reproducing system according to the present invention, the work decoding system 401 deciphers a coded work with user's peculiar data transmitted thereto. More specifically, the user's peculiar data stored in the storing means 407 is transmitted via the communicating means 404 and 403 to the decoding means (step S802). Also, a coded work stored in the coded work storing means 103 is transmitted to the coded work storing means 104 (step S803). The decoding means 104 receiving the user's peculiar data and the coded work deciphers the coded work with the user's peculiar data (step S804).

Controlling the decoding of the coded work with the work management data, characterizes a work reproduction system according to the seventh invention. Transmitting the work attribute data via the communicating means 403 to the user's peculiar data storing system 402, characterizes the eighteenth invention. The storing means 405 for storing the work management data, the checking mean S406 and making the decision in dependence on the result of decision in the checking means 406 as to whether the user's peculiar data is to be transmitted to the work decoding system 401, characterizes a user's peculiar data storing system according to the twenty-second invention.

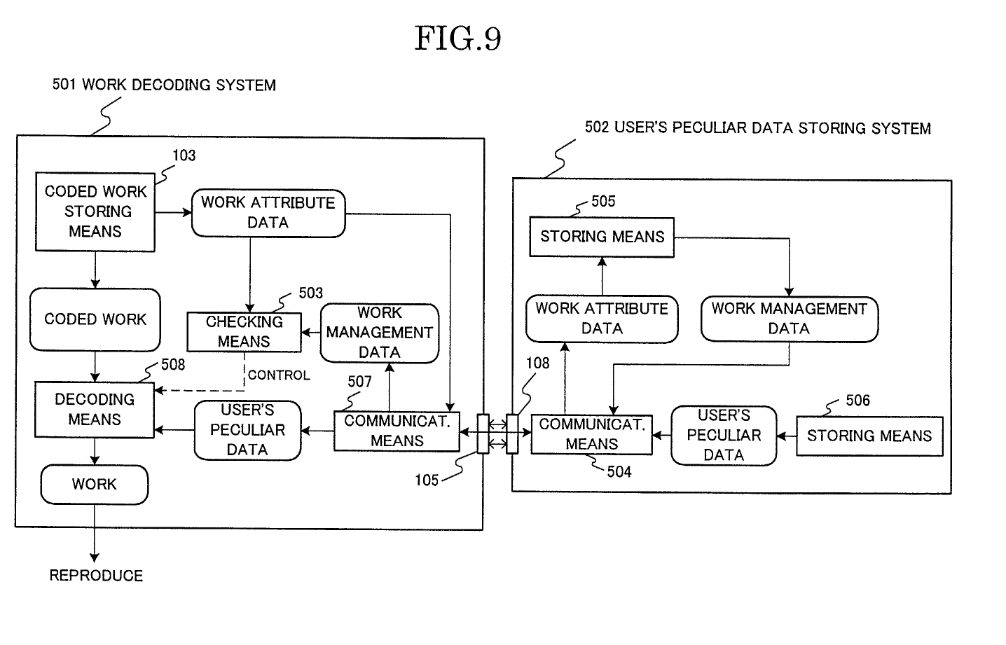

FIG. 9 is a block diagram showing a fifth embodiment of the work reproducing system according to the present invention.

The fifth embodiment of the work reproducing system is a work reproducing system according to the seventh invention, and comprises a work decoding system 501 according to the nineteenth invention, and a user's peculiar data storing system 502 according to the twenty-third invention.

In claim 7, it is set forth that “the coded work is allowed to be decoded when it is decided with reference to the work management data that the user has a consent for decoding the coded work”, in the fifth embodiment of the work reproducing system the work decoding system 501 is adapted to make a check as to whether a consent for decoding is present.

The work decoding system 501 includes, in addition to the work decoding system according to the eighteenth invention, a checking means 503 for making a check with reference to work attribute data of a coded work and work management data received from the user's peculiar data system 502 as to whether the coded work is allowed to be decoded.

The user's peculiar data storing system 502 includes, in addition to the user's peculiar data storing system 102 according to the twenty-first invention, a communicating means 504 for receiving work attribute data from the work decoding system 501 and a storing means 505 for storing the work attribute data.

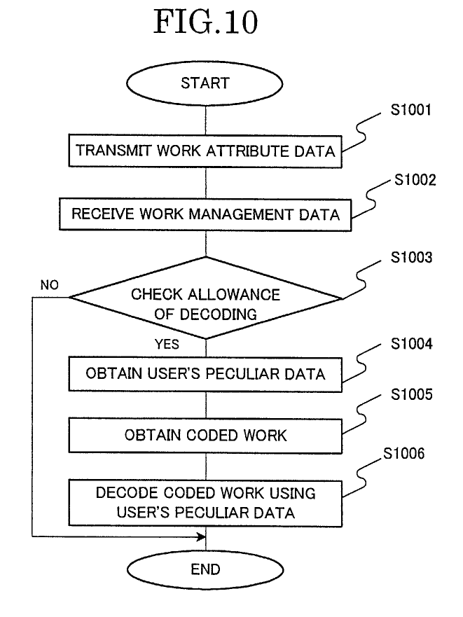

Referring to FIG. 10, the work decoding system 501 executes a process including a work attribute data transmitting step S1001, a work management data receiving step S1002, a decoding allowance checking step S1003, a coded work obtaining step S1005 and coded work decoding step S1006.

The operation of the fifth embodiment of the work reproducing system will now be described mainly in connection to the difference from the first embodiment of the work reproducing system with reference to FIGS. 9 and 10.

When it is intended to decipher a coded work stored in the work decoding system 501, the work attribute data pertaining to the coded work is transmitted via the communicating means 507 and 504 to the user's peculiar data storing system 502 (step S1001).

In the user's peculiar data storing system 502, the user's peculiar data storing in the storing means 506 and the work management data representing a work attribute among the work management data stored in the storing means 505, are transmitted via the communicating means 504 and 507 to the attribute decoding system 501.

When the work management data is received via the communicating means 507 in the work decoding system 501 (step S1002), the checking means 503 makes a check with reference to the work management data and the work attribute data as to whether the coded work is allowed to be decoded (step S1003). In the failure of decision that the coded work is allowed to be decoded, the checking means 503 does not allow the decoding of the coded work, that is, the coded work is not decoded for reproduction. When it is decided that the coded work is allowed to be decoded, the checking means 503 allows the decoding means 508 to decipher the coded work.

When the decoding of the coded work is allowed, as in the case of the first embodiment of the work reproducing system, the decoding means 508 deciphers the coded work so that the decoded work is reproduced. More specifically, the user's particular data stored in the storing means 506 is transmitted via the communicating means 504 and 507 to the decoding means 508 (step S1003). The coded work stored in the coded work storing means 103 is also transmitted to the decoding means 508 (step S1005). The decoding means 508 receiving the user's peculiar data and the coded work, deciphers the coded work with the user's particular data for the reproduction of the decoded work (step S1006).

Controlling the decoding of the coded work with the work management data, characterizes the seventeenth invention. The checking means 503 and that the checking means 503 allows the decoding of the coded work, characterize a work deciphering system according to the nineteenth invention. The storing means 505 for storing the work management data and transmitting the work management data via the communicating means 504 to the work decoding system 501, characterize a user's peculiar data storing system according to the twenty-third invention.

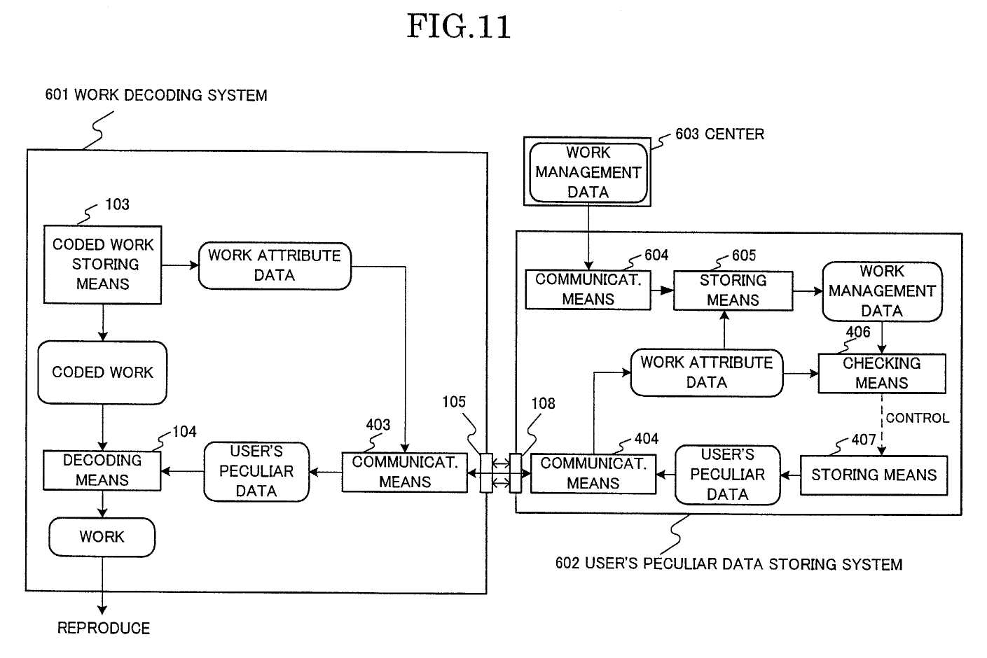

FIG. 11 is a block diagram showing a sixth embodiment of the work reproducing system according to the present invention.

The sixth embodiment of the work reproducing system is a work reproducing system according to the eighth invention, and comprises a work decoding system 601 according to the eighteenth invention, a user's peculiar data storing system 602 according to the twenty-forth invention, and a center 603.

The work decoding system 601 is the same as the work decoding system 401 in the fourth embodiment of the work reproduction system 601.

The user's peculiar data storing system 602 includes, in addition to the user's peculiar data storing system 402 according to the twenty-second invention, a communicating means 604 for communicating with the center 603.

The center 603 may, for instance, be a personal computer for producing work attribute data.

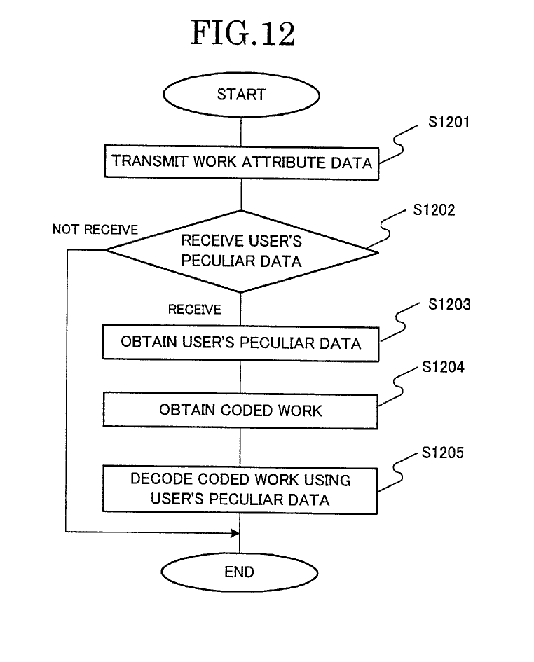

Referring to FIG. 12, the work decoding system 601 executes a process of a work attribute data transmitting step S1201, a user's peculiar data reception checking step S1202, a user's peculiar data obtaining step S1203, a coded work obtaining step S1204, and a coded work decoding step S1205.

The operation of the sixth embodiment of the work reproducing system will now be described mainly in connection with the fourth embodiment of the work reproducing system with reference to FIGS. 11 and 12.

When it is intended to decipher a coded work stored in the work decoding system 601, the work attribute data pertaining to the coded work is transmitted through the communicating means 403 and 404 to the user's peculiar data storing system 602 (step S1201).

The work management data is received from the center 603 in the communicating means 604 in the user's peculiar data storing system 602 and stored in the storing means 605 therein. In the system 602, receiving the work attribute data via the communicating means 404, what corresponds to the work attribute data among the work management data stored in the storing means 605 is handed over to the checking means 406. The checking means 406 makes a check with reference to the work management data and the work attribute data as to whether the coded work is allowed to be decoded. In the case of failure of decision that the coded work is allowed to be decoded, the checking means 406 does not allow the decoding of the work, and the user's peculiar data is not transmitted to the work decoding system 601. Thus, the work decoding system 601 does not decipher the work for reproduction. When the means 406 decides that the coded work is allowed to be decoded, it causes the user's peculiar data stored in the storing means 407 to be transmitted via the communicating means 404 to the work decoding system 601.

The details of the operation of making the check with reference to the work management data stored in the storing means 605 as to whether the coded work is allowed to be decoded, are the same as in the fourth embodiment of the work reproducing system.

As for the timing of reception of work management data, the reception takes place when the user requests the center 603 to dispatch the work management data. In the case where a fee is charged for the reproduction of a work, an obligation of paying the fee to the center 603 is generated at this time to the user, and this is settled by some or other means (for instance instantly paying the money or paying the fee with a credit card). Physically, the user commits the reception of the work management data by establishing a communication route to the center 603 in such a manner as that he or she goes with the user's peculiar data storing system 602 to the center 603, that he or she does processing with as system, which is installed in a record shop to serve as an agent for the center 603, or that he or she inserts the user's peculiar data storing system 602 in a slot of a system (such as a personal computer on his or her own home desk) connected via an internet system to the center 603.

Like the first embodiment of the work reproducing system, when the work decoding system 601 receives user's peculiar data (S1202), it deciphers the coded word for the reproduction of the decoded work as in the work reproducing system of the first embodiment. More specifically, the user's peculiar data is transmitted via the communicating means 403 to the decoding means 104 (step S1203). Also, the coded work stored in the coded work storing means 103 is transmitted to the decoding means 104 (step S1204). Receiving the user's peculiar data and the coded work, the decoding means 104 deciphers the coded work for the reproduction of the decoded work (step S1205).

Receiving the work management data from the center 603 and controlling the decoding of the coded work with the received work management data, characterize a work reproducing system according to the eighth invention. The communicating means 604 characterizes a user's peculiar data storing system according to the twenty-fourth invention.

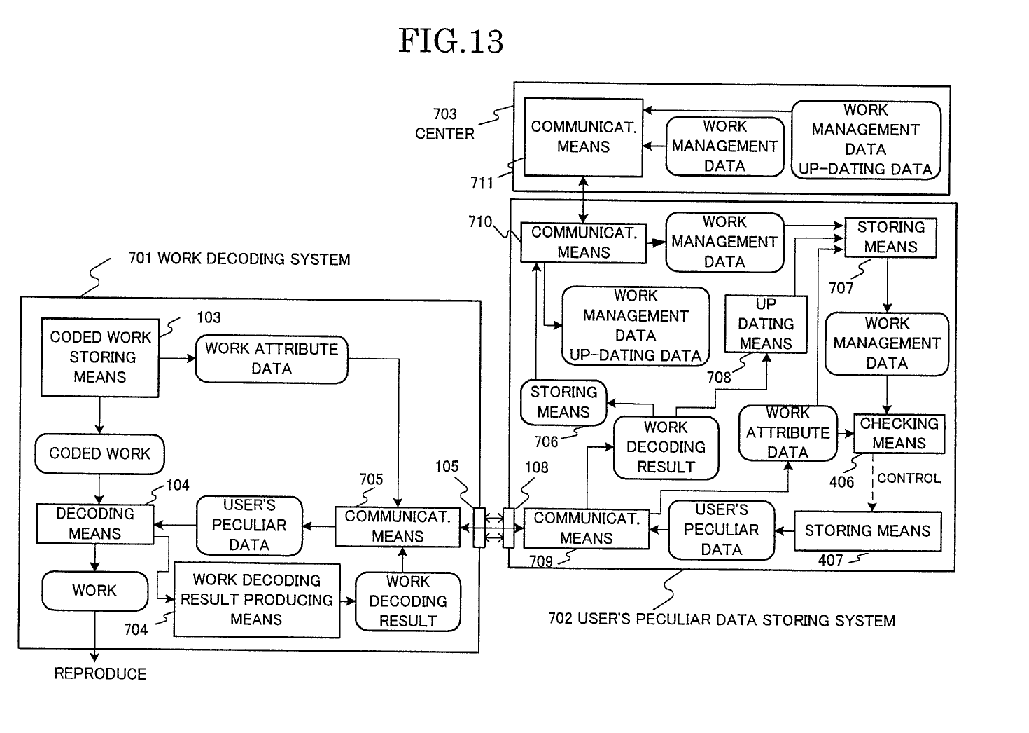

FIG. 13 is a block diagram showing a seventh embodiment of the work reproducing system according to the present invention.

The seventh embodiment of the work reproducing system is a work reproducing system according to the eleventh invention, and comprises a work decoding system 701 according to the twentieth invention, a user's peculiar data storing system 702 according to the twenty-seventh invention, and a center 703.

The seventh embodiment of the work reproducing system characterizes a work reproducing system according to the ninth to the eleventh aspects of the present invention, a work decoding system according to the twentieth invention, and a user's peculiar data storing system according to the twenty-fifth to twenty-seventh aspects of the present invention.

The work decoding system 701 includes, in addition to the work decoding system 401 in the fourth embodiment of the work reproducing system, a work decoding result producing means 704, and it has a function of transmitting a work decoding result produced in the work decoding result producing means 704 via a communicating means 705 to the user's peculiar data storing means 702.

The user's peculiar data storing system 702 includes, in addition to the use's peculiar data storing system according to the twenty-fourth invention, a storing means 706 for storing a work decoding result, and an updating means 708 for updating work management data stored in the storing means 707.

The center 701 may, for instance, be a computer for producing work management data and work management data updating data.

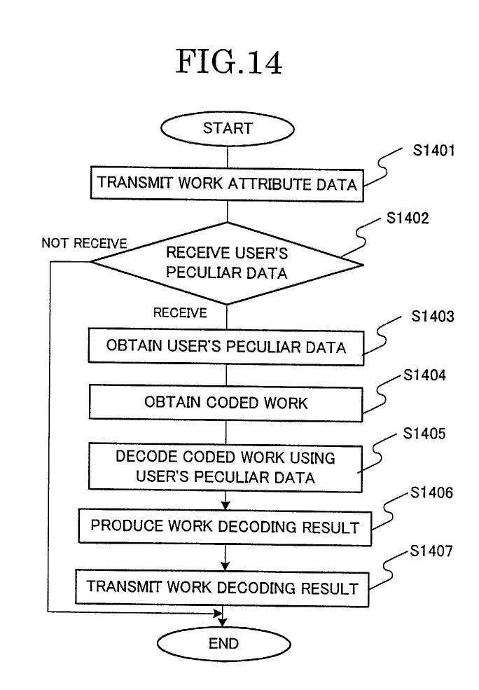

Referring to FIG. 14, the work reproducing system 701 executes a process including a work attribute data transmitting step S1401, a user's peculiar data reception checking step S1402, a user's peculiar data obtaining step S1403, a coded work obtaining step S1404, a coded work decoding step S1405, a work decoding result producing step S1406 and a work decoding result transmitting step S1407.

The operation of the seventh embodiment of the work reproducing system will now be described mainly in connection to the difference from the sixth embodiment of the work reproducing system with reference to FIGS. 13 and 14.

Like the sixth embodiment of the work reproducing system, the work decoding system 701 deciphers a coded work. More specifically, when the coded work stored in the work decoding system 701 is to be decoded, the work attribute data pertaining to the coded work is transmitted via the communicating means 705 and 709 to the user's peculiar data storing system 702 (step S1401).

In the user's peculiar data storing system 702, like the user's peculiar data storing system 602 in the sixth embodiment of the work reproducing system, a checking means 406 makes a check with reference to the work management data and the work attribute data as to whether the coded work is allowed to be decoded. When it is not decided that the decoding of the coded work is allowed, the user's peculiar data is transmitted to the work decoding system 701. When it is decided that the decoding of the coded work is allowed, the user's peculiar data stored in the storing means 407 is transmitted via the communicating means 709 and 705 to the work decoding system 701.

In the word decoding system 701, when the user's peculiar data is received (“YES” in step S1402), the decoding means 104 obtains the user's peculiar data (step S1403), obtains the coded work from the coded work storing means 103 (step S1404), and deciphers the coded work with the user's peculiar data for the reproduction of the coded work (step S1405). When the coded work is decoded, the work decoding result producing means 704 produces a work decoding result by arranging the work attribute data, the consent number of times of decoding, etc. in a predetermined format (step S1406), and transmits the produced work decoding result via the communicating means 705 to the user's peculiar data storing system 702 (step S1407).

In the user's peculiar data storing system 702, the work decoding result is received via the communicating means 709, and stored in the storing means 706 so as to be referred to by the updating means 708. The updating means 708 updates the work management data stored in the storing means 707 according to the work management data. For example, when the updating means 708 refers to a work decoding result that the coded work has been decoded in such case as when the work management data includes data restricting the number of times of decoding of a particular coded work and also data representing the residual consent number of times of decoding, it subtracts the residual consent number of times of a residual consent number of times of coding.

Also, in the user's peculiar data storing system 702, the work management data updating data is received from the center 703 via the communicating means 711 and 710, and the updating means 708 updates the work management data stored in the storing mean 707 according to the received work management data updating data. For example, when the work management data contains a command for increasing the residual consent number of times of decoding a particular coded work by a certain number (for instance 5) in the case when the work management data includes data for restricting the consent number of times of decoding the coded work and also data representing the residual consent number of times of decoding, the updating means 707 increases the residual consent number of decoding contained in the work management data concerning the pertinent coded work by a designated number (for instance 5).

The work decoding result stored in the storing means 706 is transmitted via the communicating means 710 and 711 to the center 703.

The production of the work decoding result in the work decoding system 701 and the updating of the work management data in the user's peculiar data storing system 702 with reference to the work decoding result, characterize a work reproducing system according to the ninth invention. The work decoding result producing means 704 and transmitting the work decoding result produced therein via the communicating means 705, characterize a work decoding system according to the twentieth invention. The storing means 706, the updating means 708, storing the work decoding result received via the storing means 706 and updating the work management data in the updating means 708 with reference to the work decoding result, characterize a user's peculiar data storing system according to the twenty-fifth invention. Updating the work management data in the user's peculiar data storing system 702 with reference to the work management data updating data received from the center 703, characterizes a work reproducing system according to the twentieth invention. Updating the work management data in the updating means 708 with reference to the work management data updating data received via the communicating means 710, characterizes a user's peculiar data storing system according to the twenty-sixth invention. Transmitting the work decoding result stored in the storing means 706 in the user's peculiar data storing system to the center 703, characterizes a work reproducing system according to the eleventh invention. Transmitting the work decoding result stored in the storing means 706 via the communicating means 710, characterizes a user's peculiar data storing system according to the twenty-seventh invention.

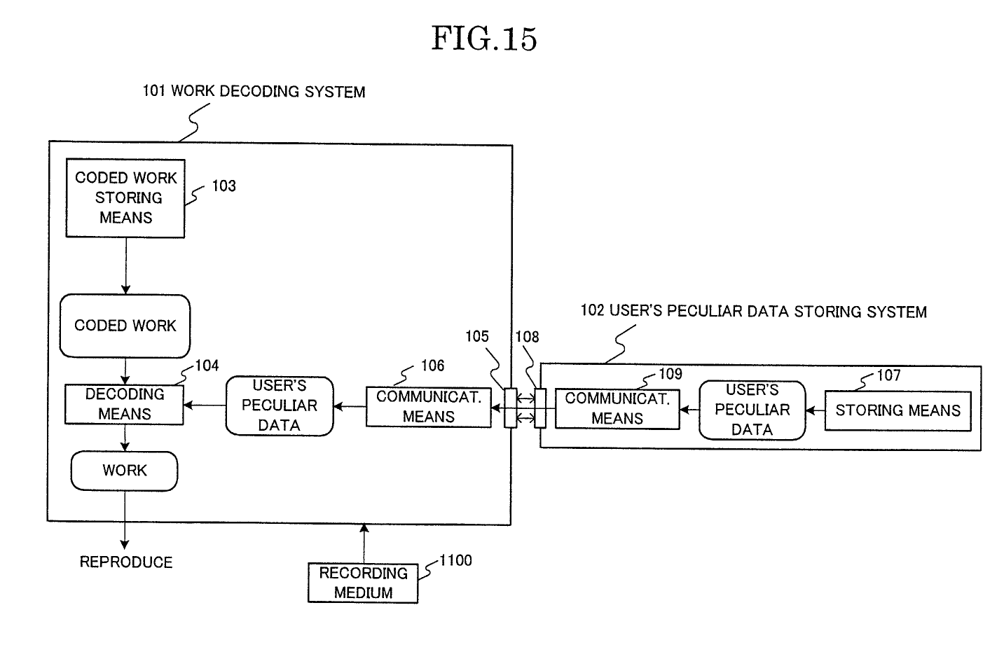

FIG. 15 is a block diagram showing an eighth embodiment of the work reproducing system according to the present invention.

The eighth embodiment of the work reproducing system is the same as the first embodiment of the work reproducing system shown in FIG. 1 except for that the work decoding system 101 further includes a recording medium 1100, in which a decoding program for realizing the decoding means 104 or the like is recorded. The recording medium 1100 may be a magnetic disc, a semiconductor memory or any other recording medium. Thus, like means are designated by like reference numerals, and are not described in detail.

In the eighth embodiment of the work reproducing system as above, the decoding program is read out from the recording medium 1100 to the work decoding system 101 to serve the role of the decoding means 104 or the like. The detailed operation of the decoding means 104 or the like is entirely the same as in the first embodiment of the work reproducing system, and is not described in detail.

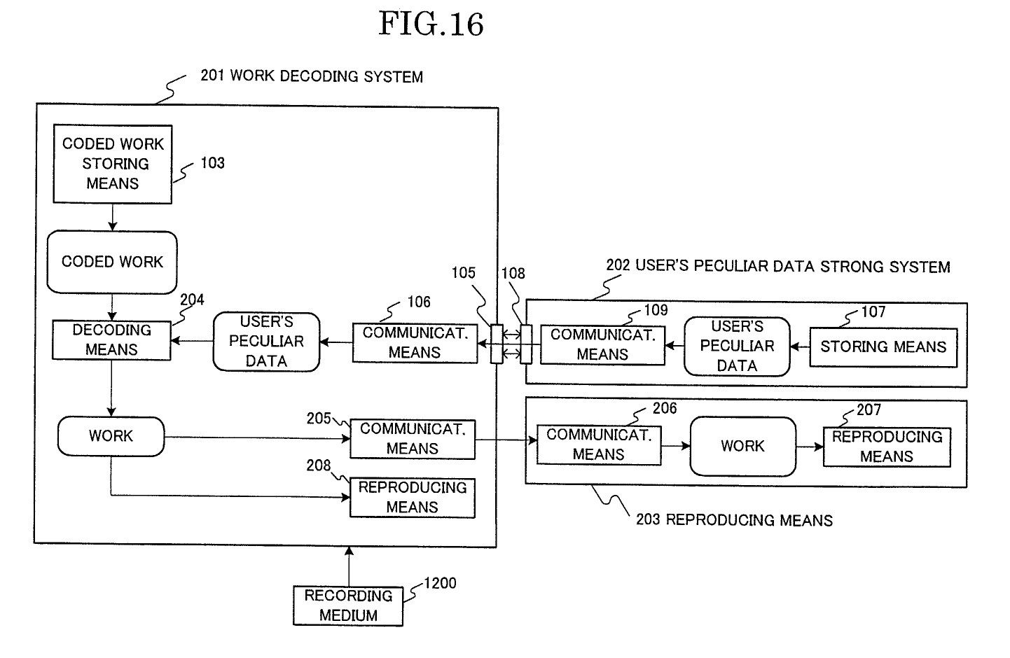

FIG. 16 is a block diagram showing a ninth embodiment of the work reproducing system according to the present invention.

The ninth embodiment of the work reproducing system is the same as the second embodiment of the work reproducing system shown in FIG. 3 except for that the work decoding system 201 includes a recording medium 1200, in which a decoding program for realizing the decoding means 204 or the like is recorded. The recording medium 1200

In the ninth embodiment of the work reproducing system as above, the decoding program is read out from the recording medium 1200 to the work decoding system 201 to serve the role of the decoding means 204 or the like. The detailed operation of the decoding means or the like is entirely the same as in the second embodiment

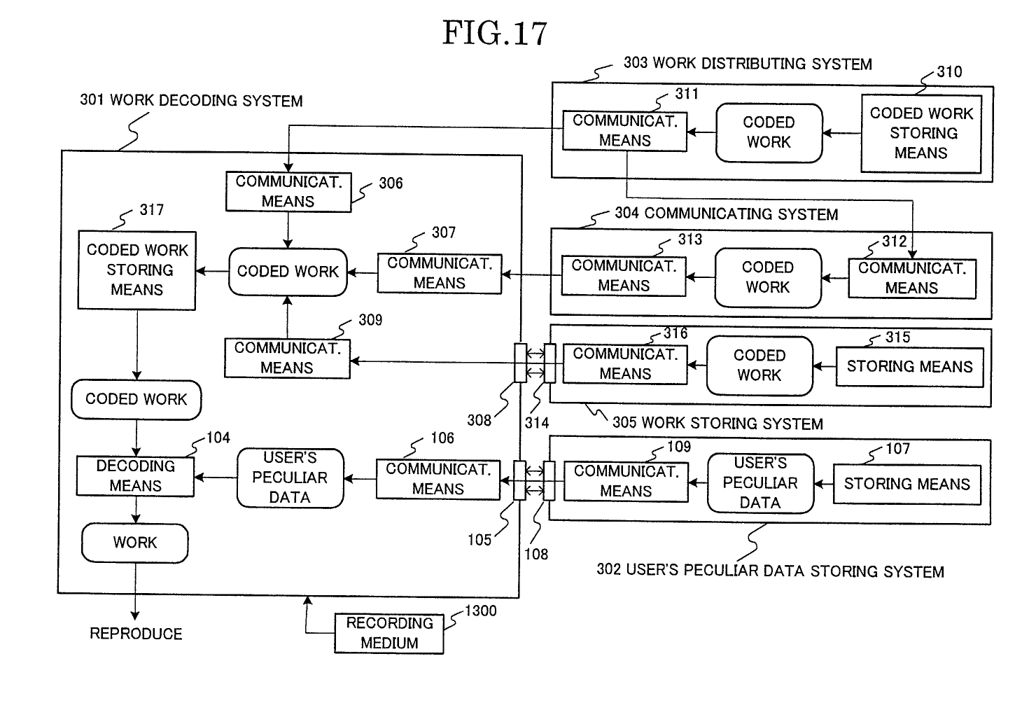

FIG. 17 is a block diagram showing a tenth embodiment of the work reproducing system according to the present invention.

The tenth embodiment of the work reproducing system is the same as the third embodiment of the work reproducing system shown in FIG. 5 except for that the work decoding system 301 further includes a recording medium 1300, in which a decoding program for realizing the decoding means 104 or the like is recorded. The recording medium 1300

In the tenth embodiment of the work reproducing system as above, the decoding program is read out from the recording medium 1300 to the work decoding system to serve the role of the decoding means 104 or the like. The detailed operation of the decoding means 104 or the like is entirely the same as in the third embodiment

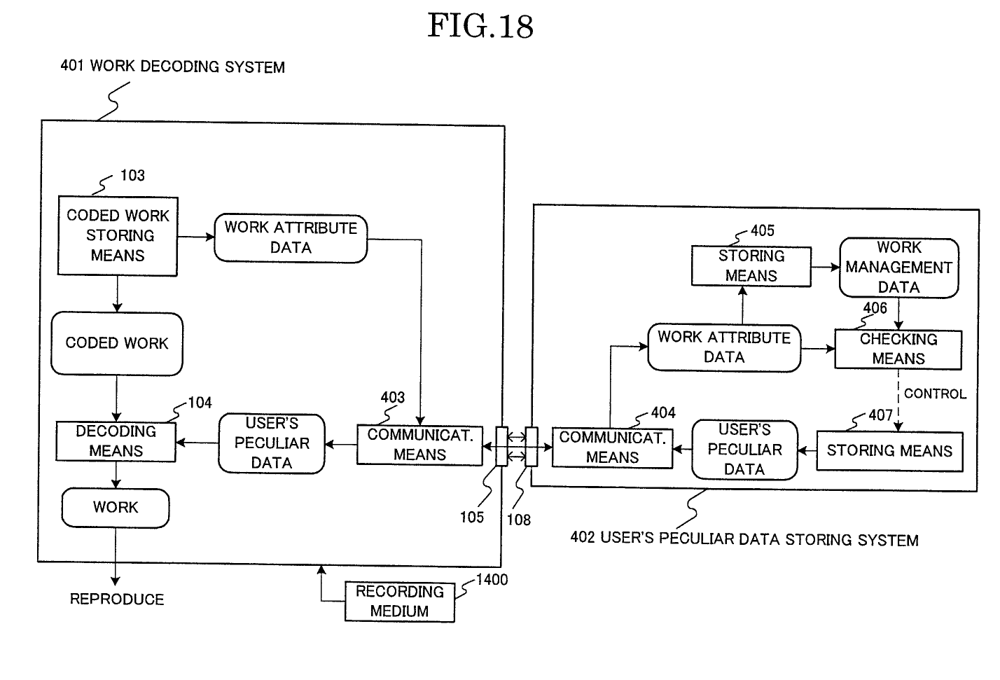

FIG. 18 is a block diagram showing an eleventh embodiment of the work reproducing system according to the present invention.

The eleventh embodiment of the work reproducing system is the same as the fourth embodiment of the work reproducing system shown in FIG. 7 except for that the work decoding system 401 further includes a recording medium 1400, in which a decoding program for realizing the decoding means 104 or the like is recorded. The recording medium 1400

In the eleventh embodiment of the work reproducing system as above, the decoding program is read out from the recording medium 1400 to the work decoding system 401 to serve the role of the decoding means 104 or the like. The detailed operation of the decoding means or the like is entirely the same as in the fourth embodiment and is not described in detail.

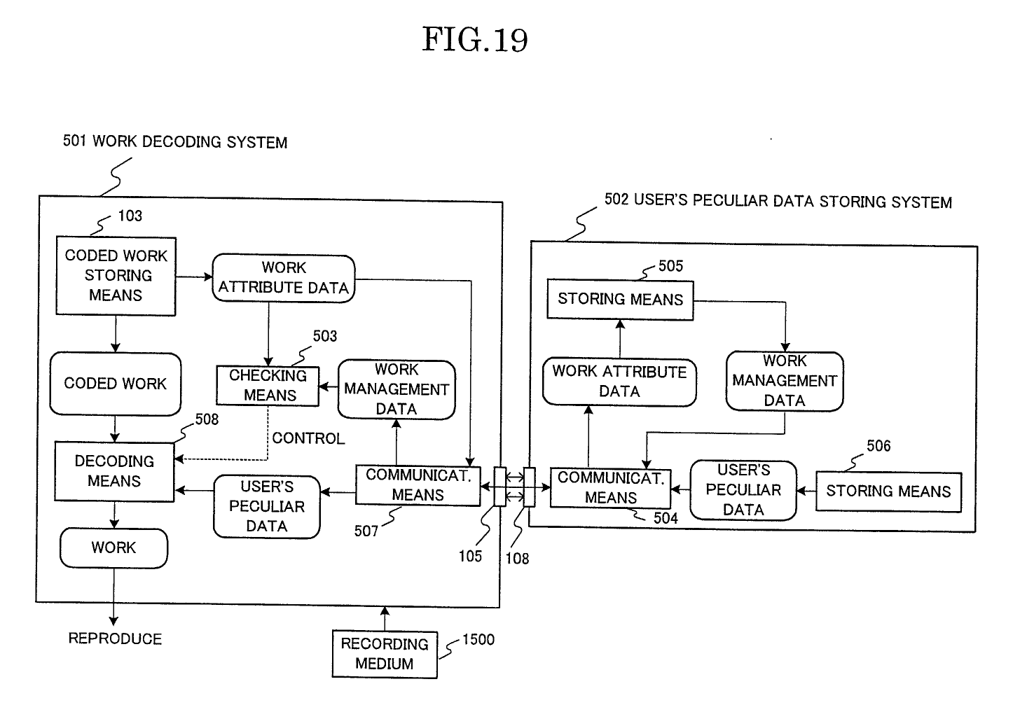

FIG. 19 is a block diagram showing a twelfth embodiment of the work reproducing system according to the present invention.

The twelfth embodiment of the work reproducing system is the same as the fifth embodiment of the work reproducing system shown in FIG. 9 except for that the work decoding system 501 further includes a recording medium 1500, in which a decoding program for realizing the checking means 503, the decoding means 508 or the like is recorded. The recording medium 1500

In the twelfth embodiment of the work reproducing system as above, the decoding program is read out from the recording medium 1500 to the work decoding system 501 to serve the role of the checking means 503, the decoding means 508 or the like. The detailed operation of the checking means 503, the decoding means 508 or the like is entirely the same as in the fifth embodiment and is not described in detail.

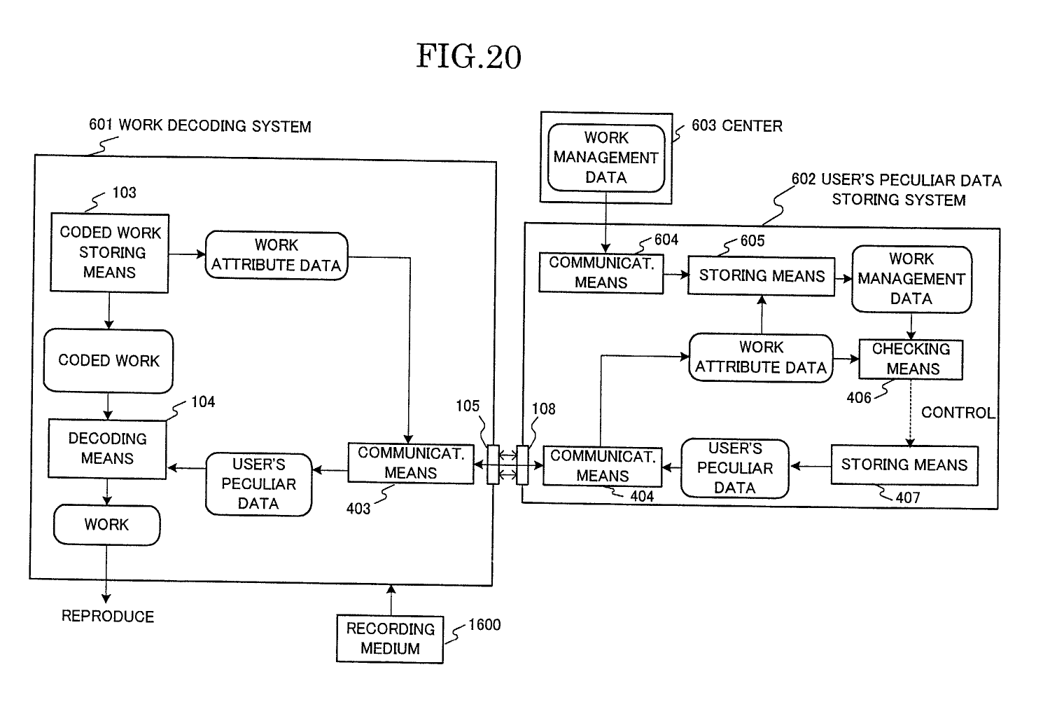

FIG. 20 is a block diagram showing the thirteenth embodiment of the work reproducing system according to the present invention.

The thirteenth embodiment of the work reproducing system is the same as the sixth embodiment of the work reproducing system shown in FIG. 11 except for that the work decoding system 601 further includes a recording medium 1600, in which a decoding program or the like is recorded. The recording medium 1600

In the thirteenth embodiment of the work reproducing system as above, the decoding program is read out from the recording medium 1600 to the work decoding system 601 to serve the role of the decoding system 104 or the like. The detailed operation of the work decoding means 104 or the like is entirely the same as in the sixth embodiment and is not described in detail.

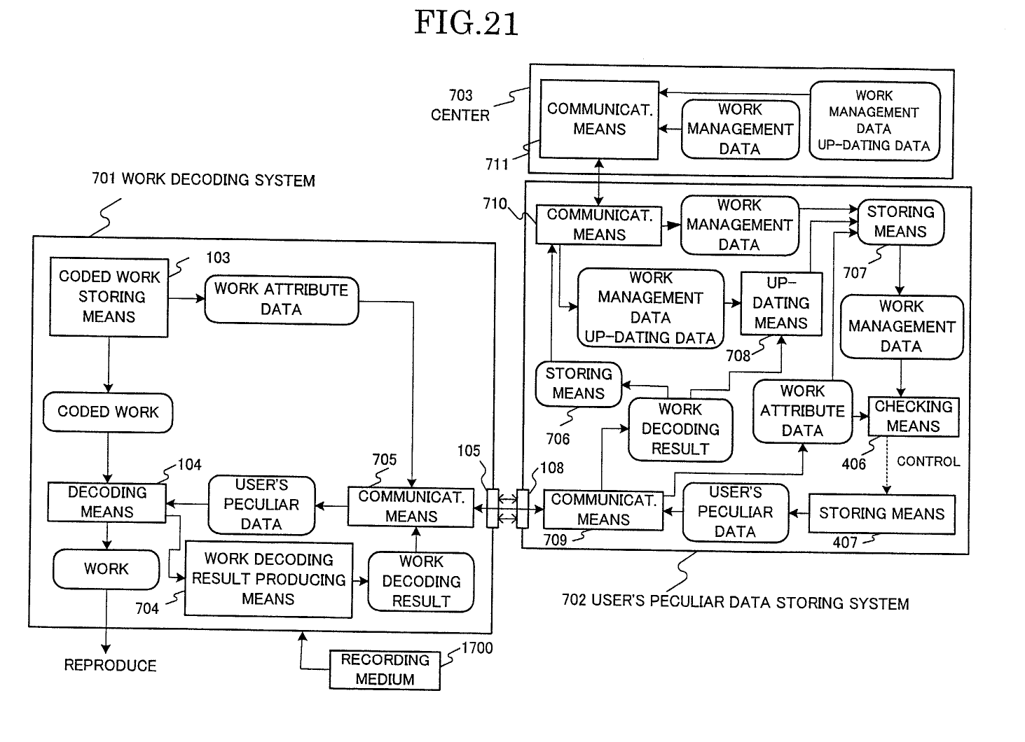

FIG. 21 is a block diagram showing a fourteenth embodiment of the work reproducing system according to the present invention.

The embodiment of the work reproducing system is the same as the seventh embodiment of the work reproducing system shown in FIG. 13 except for that the work decoding system 701 further includes a recording medium 1700, in which a decoding program for realizing the decoding means 104, the work decoding result producing means 704 or the like is recorded. The recording medium 1700

In the fourteenth embodiment of the work reproducing system as above, the decoding program is read out from the recording medium 1700 to the work decoding system 701 to serve the role of the decoding means 104, the work decoding result producing means 704 or the like. The detailed operation of the decoding means 104, the work decoding result producing means 704 or the like is entirely the same as in the seventh embodiment and is not described in detail.

According to the present invention the following advantages are obtainable.

A first advantage is to realize a work reproducing system, a work decoding system and a user's peculiar data storing system, which permit circulation of works without any particular recording medium while ensuring copyright protection. This is because the work is coded by the user's peculiar data independent of a specified recording medium.

A second advantage is to realize a work reproducing system, a work decoding system and a user's peculiar data storing system, which make it difficult for a third party, to which a user having a regularly received consent of decoding a work has circulated data received as a proof of the decoding consent, to decipher the work and infringe the copyright thereof. The reason is as follows. Since the user's peculiar data necessary for decoding a coded work is stored in a particular user's peculiar data storing system, it is difficult for the user to unfairly distribute regular user's peculiar data to a third party and thus let the third party to decode the coded work.

A third advantage is to realize a work reproducing system, a work decoding system and a user's peculiar data storing system, which permit realizing a more sophisticated work decoding consent rendering method. This is because the user's peculiar data storing system is detachably mounted in the work decoding system.

A fourth advantage is to realize a work reproducing system, a work decoding system and a user's peculiar data storing system, which permit realizing a more sophisticated work decoding consent rendering method. The reason is as follows. Since the user's peculiar data storing system can be detachably mounted in the work decoding system, even a user who uses a plurality of different work decoding systems, can decode a coded work in a desired one of the work decoding systems by connecting the user's peculiar data storing system to that work decoding system. That is, the user can decode the coded work without need of obtaining a consent of decoding for each of the work decoding systems.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A work reproducing system for reproducing a work capable of being coded by an electronic means;
the work being coded such as to be decoded with user's peculiar data preliminarily assigned to a particular user;
the work reproducing system comprising a work decoding system including a decoding means for decoding the coded work with the user's peculiar data, a user's peculiar data storing system capable of being detachably mounted in the work decoding system, and a communicating means for communicating with the user's peculiar data storing system;
the user's peculiar data storing system including a communicating means for communicating with the work decoding system, and a storing means for storing the user's peculiar data necessary for decoding the coded work; and
the user's peculiar data being transmitted from the user's peculiar data storing system to the work decoding system, the coded work being decoded in the work decoding system with the user's peculiar data.

2. The work reproducing system according to claim 1, wherein the work decoding system transmits the work as a result of decoding of the coded work to a reproducing system including a reproducing means for reproducing the work, the work being reproduced in the reproducing system.

3. The work reproducing system according to one of claims 1 and 2, wherein the work decoding system includes a reproducing means for reproducing the work, the work as a result of decoding of the coded work being reproduced in the work decoding system.

4. The work reproducing system according to one of claims 1 to 3, which further comprises a work distributing system including a communicating means for transmitting the coded work, the work decoding system including a coded work storing means for storing the coded work and a communicating means for communicating with the work distributing means, the work decoding system obtaining the coded work by communication with the work distributing system.

5. The work reproducing system according to one of claims 1 to 4, which comprises a work distributing system including a communicating means for transmitting the coded work, and a communicating system including a communicating means for communicating the work distributing system, the work decoding system including a communicating means for communicating with the communicating system, the work decoding system obtaining the coded work by communication with the work distributing system via the communicating system.

6. The work reproducing system according to one of claims 1 to 5, which comprises a work storing system capable of being detachably mounted in the work decoding system and including a storing means for storing the coded work and a communicating means for communicating with the work decoding system, the work decoding system including a communicating means for communicating with the work storing system, the work decoding system obtaining the coded work by communicating with the work storing system.

7. The work reproducing system according to one of claims 1 to 6, wherein the user's peculiar data storing system includes a storing means for storing work management data for checking whether a user as owner of the user's peculiar data storing system has a consent for decoding each coded work, and in a situation that the coded work is to be decoded with the user's peculiar data storing system connected to the work decoding system, by referring the work management data the coded work is decoded when and only when it is decided that the user has a consent for decoding the coded work.

8. The work reproducing system according to claim 7, wherein the user's peculiar data storing system includes a communicating means for communicating with a center for producing work management data, the user's peculiar data storing system obtaining work management data from the center by communicating with the center.

9. The work reproducing system according to one of claims 7 and 8, wherein the work decoding system transmits work decoding result data to the user's peculiar data storing system according to the decoding of the coded work, the user's peculiar data storing system including an updating means for updating work management data stored in it according to the work decoding result.

10. The work reproducing system according to one of claims 7 and 8, wherein the user's peculiar data storing system includes a communicating means for communicating with a center for producing work management data, the user's peculiar data storing system updates work management data stored therein according to work management data updating data received from the center.

11. The work reproducing system according to claim 10, wherein the user's peculiar data storing system includes a storing means for storing work decoding result data, stored work decoding result data being transmitted via a communicating means for communicating with the center to the center.

12. A work decoding system for decoding a coded work whiv is coded by an electronic means with user's peculiar data preliminarily assigned to a particular user, comprising:
a first connecting means for being connected to a user's peculiar data storing system for storing the user's peculiar data;
a first communicating means for communicating with the user's peculiar data storing means with the first connecting means connected thereto;
a coded work storing means for storing the coded work;
a decoding means for receiving the coded work stored in the coded work storing means and user's peculiar data obtained from the user's peculiar data storing means via the first connecting means in the first communicating means and decoding the coded work.

13. The work decoding system according to claim 12, which further comprises a second communicating means for feeding out the decoded work obtained by decoding in the decoding means to the outside.

14. The work decoding system according to one of claims 12 and 13, which further comprises a reproducing means for reproducing the decoded work obtained by decoding in the decoding means.

15. The work decoding system according to one of claims 12 to 14, which further comprises a third communicating means for storing the coded work and communicating with a work distributing system.

16. The work decoding system according to one of claims 12 to 15, which further comprises a fourth communicating means for communicating with a communicating system including as communicating means for communicating with a work distributing system for storing and transmitting the coded work.

17. The work decoding system according to one of claims 12 to 16, which further comprises a second connecting means of being connected to a work storing system including a storing means for storing the coded work and a fifth communicating means for communicating with the work storing system.

18. The work reproducing system according to one of claims 12 and 17, wherein when the coded work is to be decoded, work attribute data pertaining to the coded work is transmitted via the first communicating means to the user's peculiar data storing system.

19. The word decoding system according to claim 18, wherein work management data stored in the user's peculiar data storing system as data for checking whether a consent for decoding the coded work is present is obtained from the user's peculiar data storing system via the first communicating means and is referred to in a check as to whether the user has a consent for decoding the coded work, and when and only when it is decided that the user has the consent for decoding the coded work is decoded in the decoding means.

20. The word decoding system according to one of claims 12 to 20, which further comprises a work decoding result producing means for converting the history of decoding in the decoding means as a work decoding result to data capable of being processed in the user's peculiar data storing system, and a communicating means for transmitting the work decoding result via the first communicating means to the user's peculiar data storing system.

21. A user's peculiar data storing system for storing user's peculiar data used for decoding a coded work, comprising:
a first storing means for storing the user's peculiar data;
a connecting means for connecting the user's peculiar data storing system to a work decoding system; and
a first communicating means for communicating with the work decoding system.

22. The user's peculiar data storing system according to claim 21, which fur and is not described in detail.ther comprises a second storing means for storing work management data for checking whether a consent for decoding each coded work to be decoded in the work decoding system is present, and a checking means for checking whether a consent for decoding a coded work is present when the coded work is to be decoded in the work decoding system.

23. The user's peculiar data storing system according to claim 21, which further comprises a second storing means for storing work management data for checking whether a consent for decoding each coded work to be decoded in the work decoding system is present, work management data concerning a coded work being transmitted via the first communicating means to the work decoding system when the coded work is to be decoded in the work decoding system.

24. The user's peculiar data storing system according to one of claims 22 and 23, which comprises a second communicating means for communicating with a center for producing the work management data, work management data being obtained from the center via the second communicating means.

25. The user's peculiar data storing system according to one of claims 22 to 24, which comprises a communicating means for receiving work decoding result data from the work decoding system, a third storing means for storing the work decoding result data, and an updating means for updating the work management data stored in the second storing means according to the work decoding result.

26. The user's peculiar data storing system according to one of claims 24 and 25, which comprises a second communicating means for communicating with a center for producing the work management data, and an updating means for updating the work management data stored in the second storing means, the updating means updating the work management data according to work management data updating data received from the center.

27. The user's peculiar data storing system according to claim 26, which comprises a communicating means for transmitting work decoding result data stored in the third storing means to a center for producing the work management data.

28. A recording medium with a record therein of programs for causing a computer to execute a procedure of obtaining user's peculiar data from a user's peculiar data storing system, procedure of obtaining a coded work from a coded work storing means, and a procedure of decoding the coded work with the user's peculiar data.

29. A recording medium with a record therein of programs for causing a computer to execute a procedure of obtaining user's peculiar data from a user's peculiar data storing system, a procedure for obtaining a coded work from a coded work storing means, a procedure of decoding the coded work with the user's peculiar data, and a procedure of transmitting the decoded work to a reproducing system.

30. A recording medium with a record therein of programs for causing a computer to execute a procedure of obtaining user's peculiar data from a user's peculiar data storing system, a procedure of obtaining a coded work from a coded work storing means, a procedure of decoding the coded work with the user's peculiar data, and procedure of producing the decoded work in a reproducing means.

31. A recording medium with a record therein of programs for causing a computer to execute a procedure of down-loading coded work from a work distributing system in a coded work storing means, a procedure of obtaining user's peculiar data from a user's peculiar data storing system, a procedure of obtaining a coded work from a coded work storing means, and a procedure of decoding the coded work with the user's peculiar data.

32. A recording medium with a record therein of programs for causing a computer to execute a procedure of transmitting work attribute data from a coded work storing means to a user's peculiar data storing system, a procedure of obtaining user's peculiar data from the user's peculiar data storing system, a procedure of obtaining a coded work from the coded work storing means, and a procedure of decoding the coded work with the user's peculiar data.

33. A recording medium with a record therein of programs for causing a computer to execute a procedure of transmitting work attribute data from a coded work storing means to a user's peculiar data storing system, a procedure of receiving the work management data from the user's peculiar data storing system, a procedure of checking whether the coded work stored in the coded work storing means can be decoded on the basis of the work management data, a procedure of obtaining user's peculiar data when the coded work can be decoded, a procedure of obtaining the coded work from the coded work storing means, and a procedure of decoding the coded work with the user's peculiar data.

34. A recording medium with a record therein of programs for causing a computer to execute a procedure of transmitting work attribute data from a coded work storing means to a user's peculiar data storing system, a procedure of checking whether user's peculiar data could have been received from the user's peculiar data storing system, a procedure of obtaining user's peculiar data when the user's peculiar data could have been received, a procedure of obtaining the coded work form the coded work storing means, and a procedure of decoding the coded work with the user's peculiar data.

35. A recording medium with a record therein of programs for causing a computer to execute a program of transmitting work attribute data from a coded work storing means to a user's peculiar data storing system, a procedure of obtaining user's peculiar data from the user's peculiar data storing system, a procedure of obtaining the coded work from the coded work storing means, a procedure of decoding the coded work with the user's peculiar data, a procedure of producing the work decoding result, and a procedure of transmitting work decoding result data to the user's peculiar data storing system.
